(19) United States
(12) Patent Application Publication
(10) Pub. No.: US 2023/0090737 A1
(43) Pub. Date: Mar. 23, 2023

(54) INTEGRATED SEA-GROUNDWATER AND TUNED OUTFALL DESALINIZATION SYSTEM

(71) Applicant: New Water Group LLC, Costa Mesa, CA (US)

(72) Inventors: Larry E. Fanning, JR., Costa Mesa, CA (US); Steve Strickler, Costa Mesa, CA (US)

(21) Appl. No.: 17/949,814

(22) Filed: Sep. 21, 2022

Related U.S. Application Data
(63) Continuation of application No. 63/261,458, filed on Sep. 21, 2021.

(51) Int. Cl. C02F 1/26; C02F 1/74

(52) U.S. Cl. CPC C02F 1/265; C02F 1/74; C02F 2103/08

(57) ABSTRACT

A sea-groundwater source is piped via a multi-barreled pipeline system into an affected area having increased salinity. Some of the water will be used for desalination efforts, and as those are coming online, the water will be used to refill and stabilize the affected area. The system of the present invention also includes a return Brine-Line that conveys brine residuals from desalination and ongoing reclamation efforts responsibly and safely into the sea where it is diluted, blended and aerated in a deep water offshore array that utilizes tidal and persistent regional currents to ultimately convey the outfall into the ocean.

### RELATED APPLICATIONS

The present application claims the benefit of priority to U.S. Provisional patent application Ser. No. 63/261,458, titled “INTEGRATED SEA-GROUNDWATER AND TUNED OUTFALL DESALINIZATION SYSTEM” filed Sep. 21, 2021, and currently co-pending.

### FIELD OF THE INVENTION

The present invention relates generally to the extraction and desalinization of seawater. The present invention is more particularly useful for the introduction of fresh water to use in the environmental reclamation of land to maintain habitat and improve land quality, and the disposal of the resulting high salt content brine water.

### BACKGROUND OF THE INVENTION

The Colorado River utilization has reached a critical point. As a resource with ever increasing demand and dwindling capacity, there is a point where no amount of conservation alone will be enough. Overreliance and climate change have created a demand that cannot be reliably met naturally by the Colorado River. Currently, there are no known feasible meaningful alternative water supplies to turn to. The only feasible answer is making new water. Note that this solution must be scaled to the task at hand. The solution must be of similar scale—millions of acre-feet per year. Similarly, the energy demand will be of a like scale. The time frame of operation will be essentially ongoing, hence sustainability is key. In a preferred embodiment, the present invention is well suited to assist the Gulf of California (aka Sea of Cortez) as one of the most diverse and critical habitats on Earth—so not only does the system need to minimize any negative impacts, it should also help correct damage already done. This dire environmental circumstance creates a need for a sustainable, large scale and economically reasonable solution.

Studies have been performed that identified that there was a common connection between water demand and environmental challenges. For instance, the connection is related to the change in use and demand of the Colorado River, as well as climate change driving a shift to warmer, drier times. Studies also identified that the damming of the Colorado River and human development altered the region's ability to flush itself of accumulated salts and wastes—instead over that last 85 to over 100-years, the river was channelized and controlled, and the water used such that the river literally no longer made flow into the Gulf. As also identified, the waters of the Colorado hold about 1-ton of salt per acre-foot, and much of this salt load was forced to accumulate in the area. With a flow rate in the 1900's of 16.3 Maf/yr, that translates into a lot of salt damage. Since every drop is literally spoken for and the River was blended with drainage waters of the Gila/Wellton, by the time the river flow arrived a Morelos Dam in Mexico, it often had a very high salinity, and no water quality provisions were provided by treaty.

The studies identified that fugitive salt dusts were likely a major part of the source of respiratory disease issues, and salt and silt choking of delta, estuary and lower valley cropland was a primary cause of environmental degradation. In the USA, when the Quantification Storage Agreement (QSA) was forced by the courts, a large volume of water used for maintaining the Salton Sea was repurposed for use elsewhere. This caused an immediate decline in water level and quality in the Salton Sea, and exposes salt encrusted shorelines infused with toxins and heavy metals—and creating a huge environmental nuisance.

Prior to humankind, for millions of years, the River, the Valley/Delta, and the Sea (Gulf) created a system to keep the area flushed, and accumulated salts put where they belong—in the ocean. As the river enters the region known as the Salton Trough, it has a choice of two sumps—to the north were the lowlands of the Salton Sink and Imperial/Coachella Valleys—largely at elevations below sea level, and to the south, into the Gulf. This resulted in the river periodically flowing north into Imperial, then redirecting flow southerly into the Gulf. During periods where the river flowed northerly, Lake Cahuilla was created and filled to a point (about 300-ft deep) where it overflowed through Mexicali into the Gulf, carrying away salts.

The studies identified that changed conditions by the dams and other controls hand in hand with human development would not feasibly allow for the return of the natural system, however, there were key resources and conditions present that could be integrated to not only address the damage, but produce a sizable volume of desalinated water as a by product.

With regard to salts and runoff, the studies found that salt is the enemy. Salt has only one safe final disposal destination—the ocean. Like so many areas that are arid and irrigated using imported water, it is inevitable that the naturally occurring salts in Colorado River water continue to accumulate and damage habitat and environmental quality unless provided a means to be flushed or removed is provided. Again, the flushing/removal systems need to be properly scaled to the influx rate. Every acre foot applied contains one ton of salt, which remains following evaporation. 1 million acre-feet will leave 1-million tons of salt. It is easy to see that huge amounts of salt—far more than can ever be handled as landfill—can accumulate in short order. For instance, in the case of the Salton Trough (Lower Mexicali Valley/Salton Sea) this has been accumulating by millions of tons per year for decades, and the effects easily seen, and has severely damaged the delta habitat that is critical to the Gulf, as well as the degradation of environmental health and quality in the developed areas of Mexicali/Imperial and Coachella.

These findings of the studies outlined a dire environmental condition which though long-felt, has yet to be addressed. In light of the long-felt need and dire circumstances, it would be advantageous to provide a backbone for treatment of harsh environmental conditions in areas that have experienced use changes that result in harmful environmental effects such as drought, elevated salt levels, poor air quality, and other negative attributes of such environmental conditions. It would be further advantageous to provide a backbone for its implementation which includes raw sea-groundwater extraction fields, conveyance, processing and energy production, delivery/service lines, and outfall to address salt accumulation and related damage and produce millions of acre-feet of fresh water. For instance, it would be advantageous for the reclamation of damaged environments that the key aspects of an embodiment of the present invention, such as that applied to the Colorado River, Salton Trough, and Sea of Cortez, would include:
Improvements to infrastructure in Mexicali Valley and Northern Gulf;
Drainage and disposal of salt and salty waterlogged lands—reclaiming them for beneficial uses;
Addressing the pollution issues of the New River and Alamo River;
Reclamation and recovery of the geothermal fields of Cerro Prieto and South Salton Sea KGRA;
Development of water banking facilities to park spare capacity water generation for future use (East Mesa, not discussed here);
Diversions of water for habitat reclamation;
Stabilization of the Salton Sea and drowning of the playas;
Providing a responsible means of salt drainage and disposal;
Providing millions of acre feet of fresh water.
Returning meaningful perennial flow of river water through the delta and estuary.

It would be further advantageous to provide components that all support the primary backbone to provide solutions to challenged environmental conditions which links, for instance, the trinity of the Salton Trough: the Northern Gulf, the Colorado River, and the Geothermal Reserves.

### SUMMARY OF THE INVENTION

A sea-groundwater source is piped via a multi-barreled pipeline system into an affected area having increased salinity. Some of the water will be used for desalination efforts, and as those are coming online, the water will be used to refill and stabilize the affected area. The system of the present invention also includes a return Brine-Line that conveys brine residuals from desalination and ongoing reclamation efforts responsibly and safely into the sea where it is diluted, blended and aerated in a deep water offshore array that utilizes tidal and persistent regional currents to ultimately convey the outfall into the ocean. The system may operate off the nearly inexhaustible geothermal fields for both electricity generation for the present invention pipeline conveyance/operations and physical desalination efforts. The present invention does not depend on geothermal energy to work; it can use whatever energy is available. In some applications, heat pumps may be used to mine direct heat to perform desalinization. In other applications, the system will need conventional electricity to operate support equipment, such as pumps, etc. Two of the key aspects of the present invention are the extraction of water for desalinization and disposal of that water following reclamation efforts.

### BRIEF DESCRIPTION OF THE FIGURES

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a Schematic of present invention with prospective water users as implemented in an affected area including the Salton Sea;

FIG. 2 is a Conceptual Schematic of the present invention Desalination Process;

FIG. 3 is a Conceptual Building Layout of a present invention Desalination Plant with Phased Expansion from 25 MGD to 100 MGD;

FIG. 4 is an overview of the project location from Google Earth;

FIGS. 5A, B and C are exemplary HDD wells;

FIG. 6A-B are Common different types of Infiltrators;

FIG. 7 is a Wellpoints (Shallow vacuum pumped, jetted/driven wellpoints;

FIG. 8 is a Horizontal Directional Drilled well (HDD);

FIG. 9 is a how horizontal well flowlines spread intake over a large area and greatly lower intake velocities;

FIG. 10 depicts the Southerly Wellfields generalized location;

FIG. 11 is a generalized locations/layouts of the Northerly Wellfields—note that each individual point shown corresponds to subgroups of multiple wells;

FIG. 12 is a illustrates the general layout/locations of the Delta Wellfields with each point shown corresponds to multiple (literally hundreds) wells within a grouping;

FIG. 13 presents an illustrative block diagram of the Delta Wellfields Area;

FIGS. 14A and B shows the area of Cerro Prieto, as excerpted from Google Earth (Note the Volcano (red arrow) (Inset shows oblique aerial of area—looking westerly, hill in background is volcano);

FIG. 15 presents a block diagram view of the structure underlying Cerro Prieto;

FIG. 16 shows the generalized section of the Cerro Prieto Geothermal Field with use areas highlighted;

FIG. 17 shows a typical plumbing of a double flash geothermal power plant;

FIG. 18 is a Series Parallel Water Heat Scavenging for Geothermal Desalination;

FIG. 19 is a concept of direct heat recovery;

FIG. 20 shows the specialized heat exchanger drillpipe;

FIG. 21 presents a schematic overview of the final processing;

FIG. 22 is a Eductor Venturi Basics;

FIG. 23 shows the generalized current pattern;

FIG. 24 illustrates pipeline anchoring;

FIG. 25 illustrates pipeline anchoring;

FIG. 26 shows a general overview of the Brineline Return, Shorefall Processing and Offshore Transport and Disposal;

FIG. 27 shows a general section of the Manifold and Eductor;

FIG. 28 Illustrates the Range of Motion of the Eductors (motion is about 50 to 70-deg, lock to lock, 360-deg about gimbal;

FIG. 29A-D shows how the educator is tuned. Note that the Nozzle includes removable components that include the tip, the sea, and pintle so that the proper flow can be used and service is simplified;

FIG. 30 is a Shows the Range of Focus of the Eductor Array;

FIG. 31 is a Shows the turbolator to be added to the Venturi Cone; and

FIG. 32 is a Illustrates how the Eductor plume propagates.

### DETAILED DESCRIPTION OF THE PRESENT INVENTION

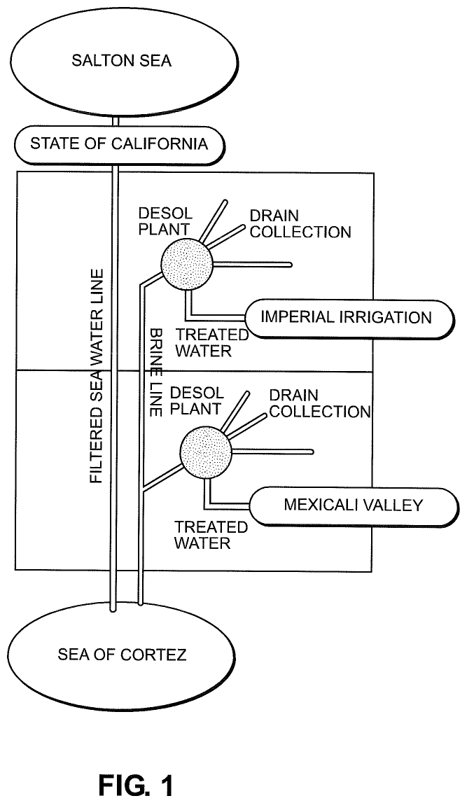

The present invention is a state-of-the-art pipeline system that allows generally for transfer of substantial volumes of water in and out of an affected area to remediate the area and to provide solutions to dire environmental conditions, and may be applied in any environmental condition suffering from increased salt loads, lower water flow, and poor air quality from the airborne silt. A suitable example for application of the present invention is the overall Salton Trough. At a glance, the present invention is an infrastructure program that includes the following major components (see also FIG. 1):
Salt water wellfields— A network of near-shore wellfields adjacent the sea that produce saline groundwater from shallow strata with direct hydrologic interconnections with the ocean.
Salt water supply pipelines— A system of large-volume pipelines to the State for direct delivery of 1,000,000 acre-feet (AF) per year of groundwater into the affected area and delivery as feedstock for a desalination program.
Desalination plants— A series of scalable desalination plants in the area to supplement long-term water supplies for regional water users; and
Regional brine disposal pipeline— A pipeline from the affected area into the deep water of the ocean (25 miles offshore of San Felipe) used for environmentally safe disposal of brine from desalination plants and other accumulated salts in the affected area.

### Benefits to the Affected Areas

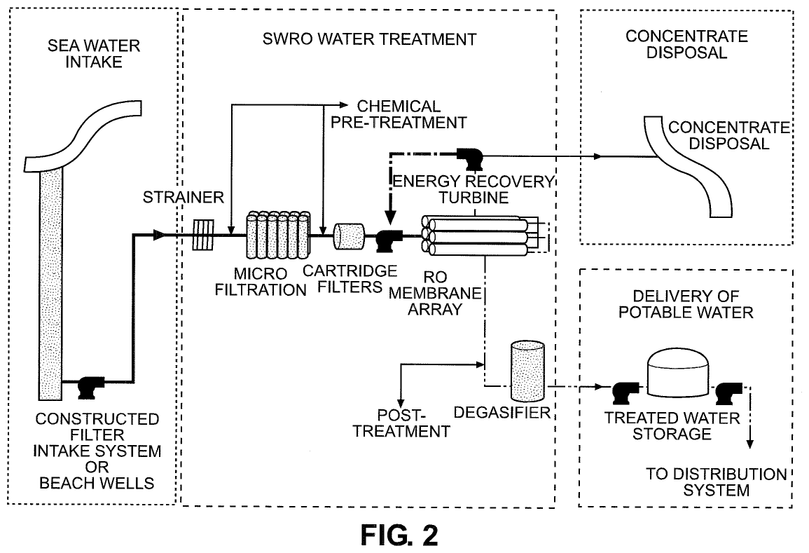

When implemented, the present invention would result in significant environmental improvements. First, the water level elevation of affected area, such as the Salton Sea, can be stabilized. For example, a stable water elevation of −227 feet below sea level could be achieved within 7 years of seawater deliveries with allowance for ongoing maintenance make-up water and possible future partial draining of hypersaline waters, should those aspects be desired (FIG. 2). The present invention would result in essentially immediate re-submerging of toxic playas and immediate reductions in their associated health risks. With Sea elevation stabilized and maintained, the environmental risks posed by exposed playas would no longer exist. Therefore, public exposures to air-borne carcinogens, dust, and residue from toxic/unhealthful chemicals and organics would be largely eliminated.

In the near-term, present invention would significantly reduce the salinity concentration of the affected area. Note that the expected condition under the present invention scenario is that the salinity concentration curve dips and flattens during the initial filling period.

This initial dilution effect gives a long-term “offset” to salinity concentration increases that are currently projected without the present invention, particularly over the upper bound worst likely case. The imported filtered seawater from the ocean would also begin immediately diluting toxic/unhealthful chemicals and organics in affected area, improving overall water quality. In the long-term, as brine was exported from the affected area for disposal, the core problem of net salt-loading could be addressed and the trajectory of increased salinity further reduced by additional water treatment programs. The present invention brine disposal line could also provide the backbone for optional follow-on wastewater treatment plants that would address water quality problems in and reclamation of impaired groundwater in the region. Such projects would improve water quality for agricultural and municipal uses and allow for the release of the water to improve environmental conditions in the affected area.

### Other Environmental Benefits of Present Invention

Energy is an essential component in most water conveyance systems that rely on pumping. Geothermal energy resources are prevalent in the Salton Trough. There is an opportunity to co-locate desalination/treatment facilities near geothermal resources so that present invention is a “green Energy project”. The geothermal energy is essentially inexhaustible if properly utilized. It also is of a perfect thermodynamic nature for water distillation.

The present invention's use of slant drilling and conventional well fields tapping into aquifer sediments in contact with or otherwise recharged by seawater rather than the conventional open intake for conveying seawater into the pipeline system. This “sea-groundwater” approach, despite the very large volumes of intake water, sharply reduces the environmental impact of the project, and has virtually no long-term detriment to marine life. This methodology also pre-filters seawater to improve performance and limit biologic cross-contamination.

The present invention will use new state of the at brine dilution and dispersion technology in combination strategically locating the outfall into offshore waters approximately 300-ft deep via a 25-mile undersea water pipeline to spread dispersed brine into the sea. The diluted and dispersed brine is to be targeted into the deep mid-water portion of the water column and is picked up and dispersed into the ocean by tidal and regional current systems. This assures that brine disposal does not threaten sea life. Referring to FIG. 1, a schematic is show of the present invention with prospective water users as implemented in an affected area including the Salton Sea.

### Salt Water Wellfields

Intake wellfields for production of filtered seawater from alluvium are strategically located along the coastline. The present invention wellfields will be split into two principal subareas: 1) a northerly primary, and 2) a southerly secondary group. These facilities will collect seawater via low-disturbance-footprint well groups and arrays that extend into appropriate sediments that are connected to and/or underlay the ocean. The wells, including slant, HDD, vertical, and Ranney type wells will withdraw sea-groundwater (saline groundwater) from aquiferious materials that are recharged by ocean water—either by direct contact (in the case of beach/seafloor sediments) or directly recharged by structural hydrogeologic connection (deeper sediment systems associated with the ancient Colorado River system). These sea-groundwater/saline aquifers are not associated with aquifers used for drinking or irrigation. This approach will both protect marine life and provide clean low-scale and fouling water for production use.

### Salt Water Supply Pipelines

Filtered saline and sea groundwater will be conveyed to affected area via a conveyance pipeline system that follows primarily along existing roadways, extending to a primary hub system, and from there extending along existing agricultural roads and canal right-of-ways. Ultimately the alignment heads to the affected areas and the main pipeline alignment follows along existing easement paths to minimize disruption to existing areas.

The present invention Salt Water Supply Pipelines include several control stations and connector stations. There are currently 11 such facilities proposed and located strategically along the route. Control stations are facilities that handle the treatment, blending, valving, flow regulation, backflow prevention, and booster pumping functions of the pipeline. Control Stations also are locations where waters may be diverted off the main pipeline for various uses, and to receive intake waters and brine.

Main/Major control stations will be located along the line and may optionally include a take-off lateral to serve salt/brine disposal. To control flow and reclaim some energy, a Control Station will include a turbine system. This station will also serve as the terminus of the brine disposal pipeline.

Filtered saline and sea groundwater would be conceptually discharged into the affected area. From there, it will flow through the area, with rocks serving to aerate and break the water prior to its entrance into the affected water area.

### Desalination Plants

As the water level elevation in affected area is stabilized by the present invention, a portion of the incoming seawater would be diverted to desalination plants to supplement water supplies in the region. The proposed desalination treatment process would use commercial reverse osmosis (“RO”) technology. A proposed Salt Water Wellfield would greatly reduce or eliminate the need for pretreatment of the raw seawater for suspended solids, which should result in substantial capital and operational cost savings. FIG. 2 shows a conceptual schematic of the present invention Desalination Process as implemented in the present invention including a sea water intake, sea water reverse osmosis treatment, central disposal system, and potable water distribution system.

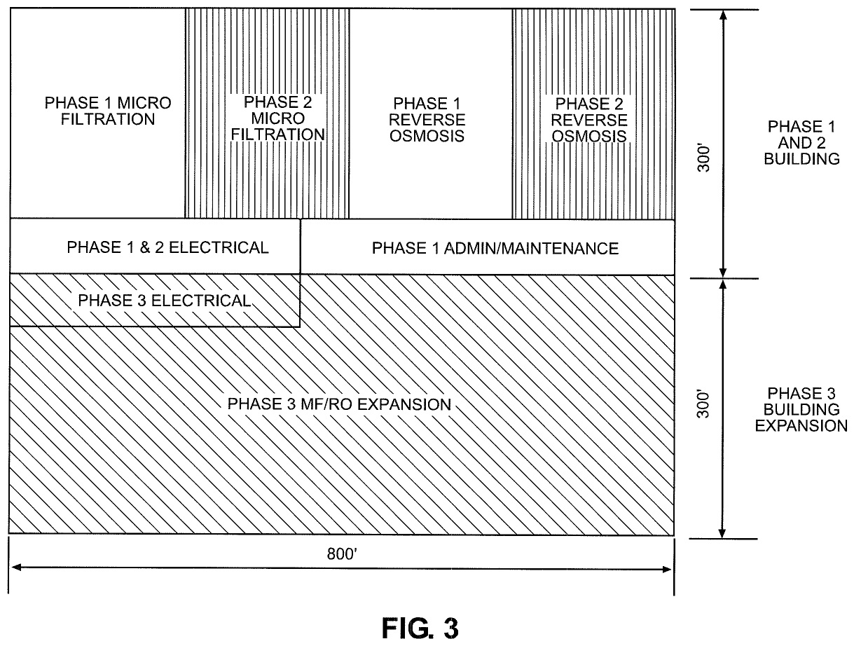

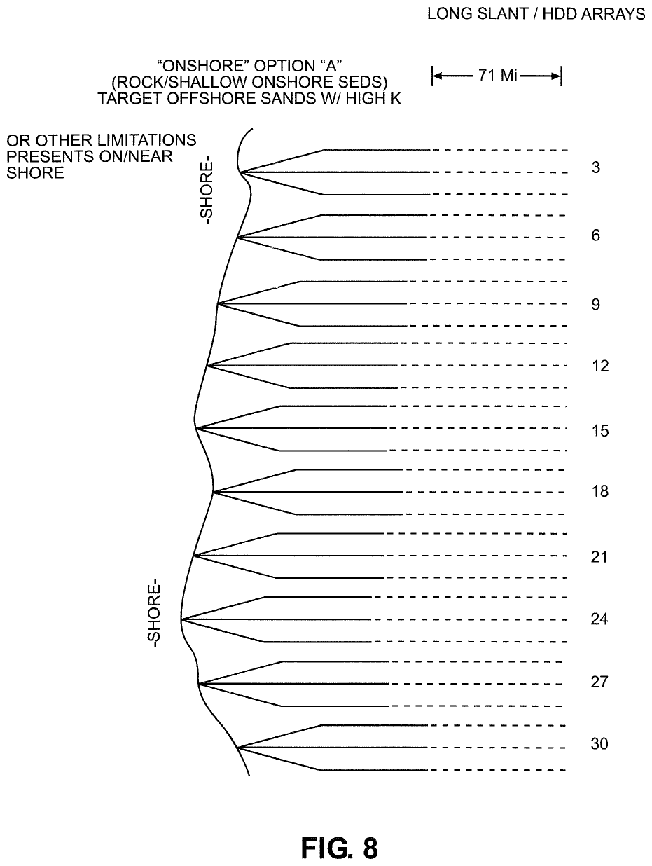

Based on preliminary conceptual analyses, each seawater desalination plant would be a 25-million-gallons-per-day (MGD) facility, expandable in phases to 50 MGD and 100 MGD (FIG. 8). The initial plant building would be large enough to accommodate the first 50 MGD in two phases. The second phase expansion cost will not have any building costs associated which will result in a lesser unit cost for the expansion to 50 MGD. The third expansion will include a mirrored building expansion and include the 50 MGD treatment expansion. The ultimate size, location and number of desalination plants will be determined as specific demands are identified and contracted. FIG. 3 depicts a Conceptual Building Layout of a present invention Desalination Plant with Phased Expansion from 25 MGD to 100 MGD

### Regional Brine Disposal Pipeline

The Regional Brine Disposal Pipeline will parallel the Salt Water Supply Pipelines over much of the overall run from the Main Control Station to the affected area of a double barrel 12-ft diameter sea-groundwater intake line and a single barrel 12-ft diameter brine disposal line. The pipeline mainline running from the Control Station to the outfall Control Station will consist of a single 12-ft dimeter sea-groundwater line and a single barrel continuance of the brine pipeline.

A terminal outfall pipeline will carry the outflow from the brine disposal line approximately 25 miles offshore to outlet in about 300 feet of water sea. The outfall will utilize state-of-the-art tuned venturi eductor systems and micro-bubbler technology to dilute, blend and disperse the discharge in an environmentally friendly and responsible manner where it will avoid both the bottom and surface portions of the water column and be picked up by the prevailing current system of the gulf and ultimately carried out to the Ocean.

### Water Source

The primary water source will be groundwater mined from wells that extend into nearshore and coastal aquifer materials. This groundwater will have a direct hydrologic connection to the ocean and will therefore be naturally-filtered sea-groundwater.

### Water Use

Because the present invention is based on importing an essentially inexhaustible source of water and has a flow capacity that exceeds the evaporative losses of most affected areas, it is considered immune to the issues of many other water sources with respect to mass balance or decreases in influx flows. The present invention will be sized to minimize energy demands and to facilitate future upgrades in flow rate capacities. It will be capable of moving sufficient volumes of water to bring the area back to a historic ‘normal’ pool level within years, with the majority of the filling happening in the first three years. This will re-submerge the playas and allow for the water level in the affected area to be maintained at a near-constant elevation.

Once the main filling of the area has been accomplished, maintenance flows will be used to make up for lost influx while the remaining flow capacity will be utilized by the region for augmenting water supplies. The best technology available will be used for desalination efforts to extract as much fresh water as possible and to minimize and concentrate brine disposal flows. The regional brine disposal pipeline will receive brine and water treatment residuals from both the desalination facilities, as well as other restoration efforts.

Evolving needs of the present invention, particularly to provide higher volumes of both fresh water and salt disposal involves:
Interchange of water and salts between the ocean and affected areas.
The principal source of intake water is naturally filtered raw sea-groundwater extracted along the ocean shore, gathered in well groups and pumped/processed by a series of control stations into a pipeline for conveyance and delivery to processing centers.
Some of the water will be gathered by reclamation efforts (from drainage and reclaiming waterlogged/salt damages areas) as the overall system evolves and added to the input supply.
The system may be supplemented by limited semi-open intakes in deep mid-water ocean areas.
Using geothermal heat mining and also using waste heat available from current energy production efforts in the production areas, the saltwater will be processed by a combination of methods using latest technology in enterprise zones to squeeze as much fresh water out as possible. A staged approach for this is envisioned, starting with high capacity lower efficiency methods first, and in series, further process with appropriate methods of increasing efficiency. The generalized efficiency is anticipated to approach 75-percent recovery or better.
The fresh, high quality water is conveyed via canal and other pipelines for ultimate delivery. Excess capacity and reclaimed waters can be banked in geologically favorable storage areas.
The resulting brine reject, along with the salt recovered from present invention reclamation efforts will be conveyed to the main backbone pipeline for conveyance to an offshore disposal area.
The disposal of the brine will be via underwater pipeline carrying the brine far offshore (about 20-25-miles) to the edge of a deep-water canyon. This brine will be processed by specialized eductors and micro-bubble injection that blend the brine thoroughly with surrounding deep ocean water and oxygenate it at a depth of about 300 to 350-feet. These eductors are tunable and will direct the plume into the midwater section where it will quickly dissipate to a condition similar to the surrounding waters. It will be picked up by the prevailing strong current system present and conveyed south into the open ocean.

Evolving needs of the Program, particularly to provide higher volumes of both fresh water and salt disposal involves:
Interchange of water and salts between the Northern Gulf of California and areas dependent on lower basin states Colorado River water.
The principal source of intake water is naturally filtered raw sea-groundwater extracted along the west side of the Northern Gulf is gathered in well groups and pumped/processed by a series of control stations into a pipeline for conveyance and delivery to processing centers at Cerro Prieto, the South Salton Sea Geothermal Area, and the Salton Sea itself.
Some of the water will be gathered by reclamation efforts (from drainage and reclaiming waterlogged/salt damages areas) as the overall ST-IWRAAP evolves and added to the input supply.
Some water may be supplemented also to the system by limited semi-open infiltrator intakes in deep mid-water ocean areas.
Using geothermal heat mining and also using waste heat available from current energy production efforts in the production areas, the saltwater will be processed by a combination of methods using latest technology in enterprise zones to squeeze as much fresh water out as possible. A staged approach for this is envisioned, starting with high-capacity lower-efficiency methods first, and in series, further process with appropriate methods of increasing efficiency. The generalized efficiency is anticipated to approach 80-percent recovery or better.
The fresh, high-quality water is conveyed via the All-American Canal (AAC), the Coachella Canal (CC), the Reforma and associated canals in Mexico and other pipelines for ultimate delivery. Excess capacity and reclaimed waters can be banked using the East Mesa and similar geologically favorable storage areas.
The resulting brine reject, along with the salt recovered from Program reclamation efforts will be conveyed to the main backbone pipeline for conveyance to an offshore disposal area located near San Felipe.
The disposal of the brine will be conveyed via underwater pipeline—carrying the brine far offshore (about 20-25-miles) to the edge of a deepwater canyon associated with the Wagner and Delfin Basins. This brine will be processed by specialized eductors and micro-bubble injection that blend the brine thoroughly with surrounding deep ocean water and oxygenate it at a depth of about 300 to 350-feet. These eductors are tunable and will direct the plume into the midwater section where it will quickly dissipate to a condition similar to the surrounding waters. It will be picked up by the prevailing strong deep water current systems present and conveyed south into the open Pacific.

### Purpose and Focus

A purpose of the present invention is to integrate all available natural resources present in the affected environment to provide a means of developing an essentially inexhaustible supply of fresh desalinated water using responsible and sustainable means on a level that can actually make a meaningful and immediate difference to regional water demands and reclamation needs. An additional purpose of the present invention is to provide a means to stop ongoing damage, address environmental health and habitat loss issues, and reclaim damaged lands and habitat for beneficial use—particularly with respect to the Salton Sea, Lower Mexicali Valley, and the upper Gulf. Another purpose is to develop, modernize and utilize the full capacity of the Cerro Prieto geothermal field to both power the project and bring vitalization. Spare capacity that is expected will be used in Mexico to assist disadvantaged areas of lower Mexicali Valley and San Felipe as part of supporting infrastructure.

One focus is on the integration of natural resources in the form of ancient delta and related sediments in contact with Gulf waters, the physical oceanographic and prevailing active current and tidal conditions of the Gulf, and the local geology, very large geothermal reserves of green energy—all put to large scale beneficial use to create a systemic solution that with proper maintenance and operation is responsible, sustainable, and essentially inexhaustible.

The raw water utilized by this system will be largely sourced in delta and coastal sediments that have been impacted by the development of hypersaline conditions from decades of accumulated evaporites of the Colorado terminus. These sediments are in contact with/recharged by contact with seawater/sea-groundwater and/or salty/impaired groundwater systems of the delta.

The invention has the added benefits of reclaiming salt and waterlog damaged lands and restoring the lower Colorado River Delta and upper Gulf. The Cerro Prieto geothermal fields will also be reclaimed and upgraded to produce power for the operation of the various components of the project, as well as produce fresh water via captured waste heat from the geothermal operations that will be used to direct drive desalination.

### Location

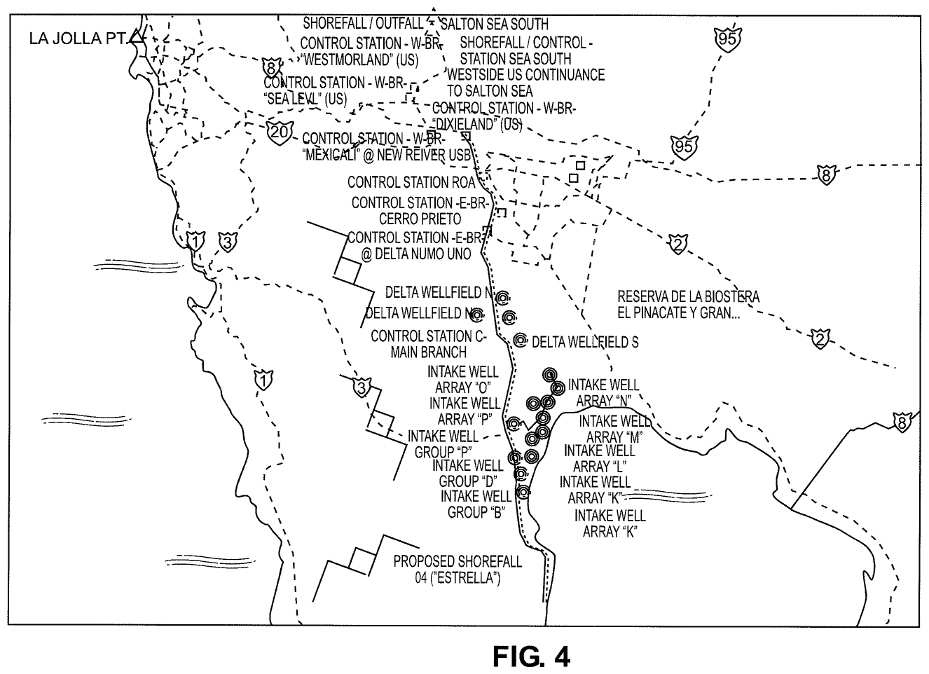

The systems of the present invention as described herein related to a preferred embodiment, are focused on the Salton Trough complex located in southeast California and northeast Baja Mexico. The production area is approximately 80 to 100 miles along the west side of the upper Gulf and Lower Mexicali Valley from approximately San Felipe to southerly Laguna Salada, Mexicali Valley Mexico. The processing hub and primary energy source will be located at Cerro Prieto, Mexicali Valley, Mexico, which is an existing Geothermal field. Service Delivery lines are planned that will carry water to the US border and All American Canal. The outfall is located at the edge of the Wagner Basin, in water 300 to 350-feet deep, approximately 20 to 25 miles offshore of San Felipe, Mexico. FIG. 4 shows an overview of the project location from Google Earth.

### System Operation

Making Fresh Water: The present invention and its operation and processes is founded on the tenant that only methods which have low environmental impact and that work with the surrounding natural conditions are utilized, and that any negatives are offset by benefits. The system must be sustainable and responsible—and utilize natural resources and green energy. The system must also be implemented and operated with the involvement of the local stakeholders and government as primary shareholders and for oversight. The basic theory of operation for the invention is using a tuned combination of advanced responsible methods to safely extract raw saline and sea groundwater, convey that water to a processing hub where it is treated and desalinated, distribute the developed product where it can be accessed by customers, and provide a specialized low impact means of disposal of the brine and related wastes. Throughout the system, the use of the most modern/advanced materials and systems are to be implemented for highest effectiveness and long-term performance. A series parallel approach to desalination energy use is also to be implemented where as much energy as possible can be scavenged. In this approach, the desalination occurs simultaneously in a primary/secondary/tertiary level, using different distillation techniques, where the brine stream and energy exhaust from the primary feeds and powers the secondary, and the brine stream and energy exhaust from the secondary feeds and powers the tertiary. Although at this point, these systems are to be determined based on field prove-up, the primary could be Vertical Tube Evaporator, secondary could be Multi Stage Flash, tertiary could be single stage evaporative. Combining this stacking approach with economy/efficiency of scale is expected to result in product recovery of 80% or more. Note that the incoming raw water will be used to cool both the produced water and final brine waste streams. Note that the system is adaptable to a variety of situational factors, and although the subject system here is developed specifically for the setting of the Salton Trough and Northern Gulf, it can be adapted for use elsewhere.

Mechanics: Overall Concept—Coastal wellfields develop sea-groundwater; sea-groundwater is conveyed by manifolds to the conveyance line to be taken to the Processing Hub. The conveyance line includes numerous Control Stations that monitor and control flow, provided metering and mixing, emergency shut-off, and allow waters to be added to/removed from the main line. At the Processing Hub, geothermal energy is used to drive desalination units and operate the related aspects of processing, and the finished products are then conveyed to delivery points along the US border/All American Canal by multi-barrel service lines. Residual brine and associated wastes are processed and removed via a Brineline system, where it is conveyed to a specified shorefall facility boosted and aerated, and then carried by offshore pipeline at the shorefall to strategic deepwater areas for disposal. The disposal uses groupings of tuned active eductors that blend the brine with surrounding seawater to eject the output into a neutrally buoyant plume that is picked up by regional currents and ultimately carried out to the East Pacific.

Raw water is developed using multiple arrays of wellfields that tap aquifers recharged by/in contact with saline or ocean water. The majority of these aquifers consist of sediment packages created by the ancient Colorado River delta complex. These aquifers also include littoral/nearshore sandy sediments and similar that are in contact with marine waters and saline groundwater. In general, these aquifers do not include fresh waters, and are not known to be used for any beneficial purposes or habitat.

Primary reasons for using the sea-groundwater approach as opposed to open intake include: 1) Has very small environmental footprint, and is not expected to harm even plankton; 2) The natural filtration capacity of the aquifer sediments filters the water, and greatly reduces scale potential and need for supplemental filtration; 3) Strategic well placement allows highly saline waters to be targeted and blended into the overall raw stock, which facilitates major reclamation objectives to reclaim critical delta and estuary habitat.

A variety of wells will be established, to be determined based on actual conditions and demands creating multiple wellfields. Details of these will be presented elsewhere herein. These wells will be manifold together into groups within well fields, and these groups manifolded into wellfield mainlines that may also include booster pumps to carry the sea-groundwater to a tie-in at a Control Station on the conveyance line.

Products: Products include Desalinated Water at salinity levels ranging from essentially distilled to near seawater. Service delivery lines, being multi-barrel, can provide up to three different products to any of the three delivery areas. Total production is estimated to be as much as 5-million acre feet per year.

By-Products: By-products include brine from desalination, possible brinestream access at co-gen sites where desalination units tap geothermal energy generation waste heat, limited reclamation disposal services (spare brineline capacity); and spare capacity developed electricity. The spare brineline capacity may be used on a fee basis to dispose of reclamation wastes such as associated with the Yuma Desalter and Salton Sea.

The resulting Reclamation programs will provide the mechanisms to fix the existing environmental quality problems and damage. The Reclamation programs will also allow for the implementation of systems that will allow for “new” water to be brought to the area, introduce recycling and reclaiming waters for habitat, urban/agricultural/industrial uses, and allow for water banking for future drought relief. These Reclamation programs, working hand in hand with jurisdictional efforts, ultimately are intended to create a region of relatively high environmental quality and character that is attractive to development and allow for sustainable expansion, urbanization, and industrialization. Habitat degraded or destroyed, predominately by salt damage and lack of proper management will be given a priority in these Reclamation programs. This will include the Salton Sea, the Lower Colorado Delta areas of Mexicali, and riparian corridors of the New River, Alamo River, Whitewater River, and watersheds associated with the lower portions of the Tijuana River and Punta Bandera.

### Major Components

### Intake

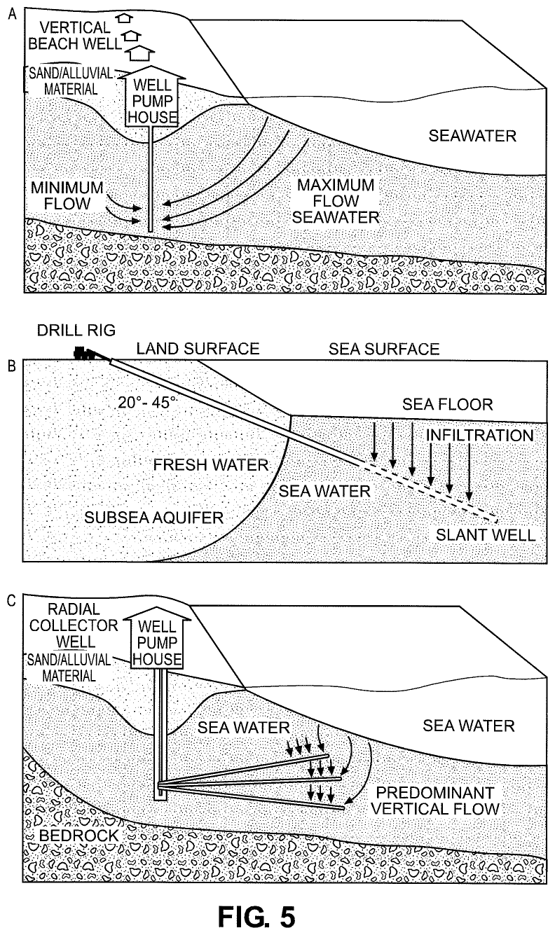

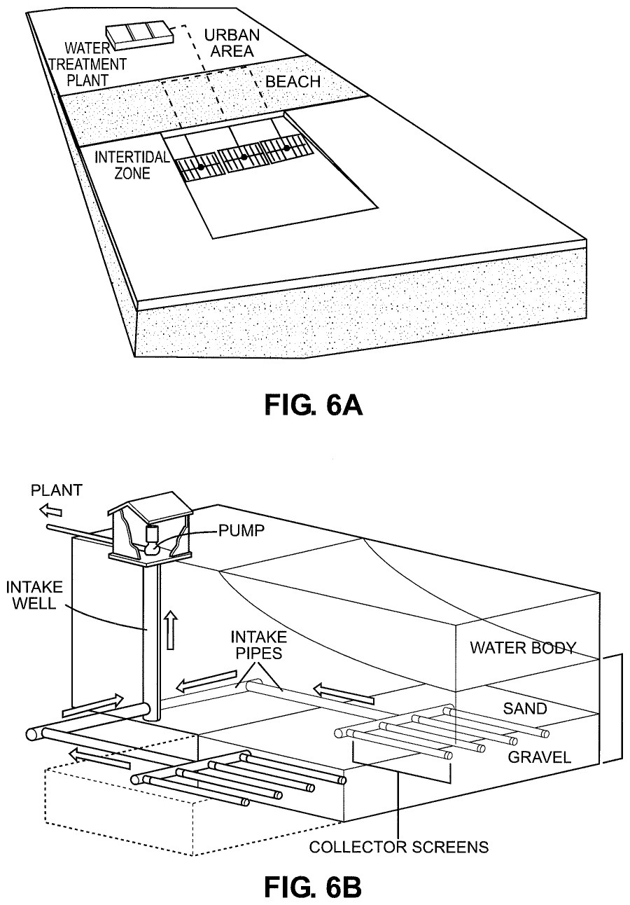

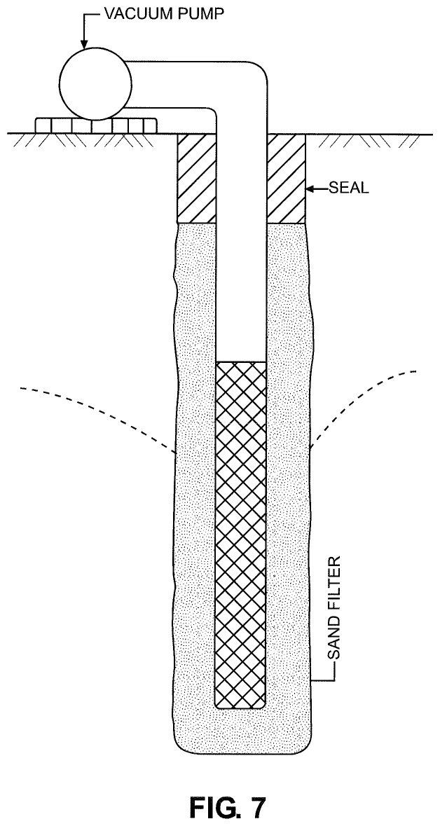

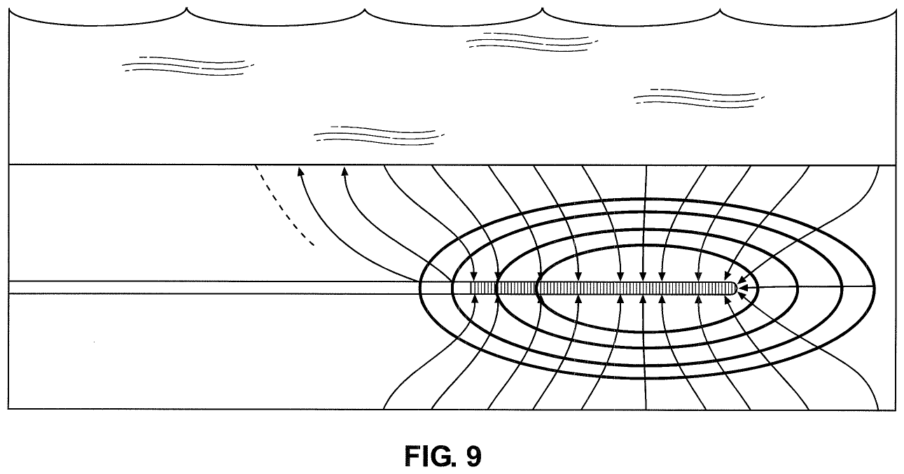

The program to provide raw sea-groundwater incorporates the following with respect to extraction and wells:
Thorough preliminary study to formulate the best fit to local conditions.
Use of multiple well types adapted to the various conditions and settings present in the wellfield areas—including:
   A) Vertical Wells
   B) Slant Wells
   C) Ranney Wells
   D) Infiltration Galleries
   E) Wellpoint Arrays
   F) HDD Wells (shown in FIG. 5A-C)
      D) Common different types of Infiltrators (Shown in FIGS. 6A-B):
      E) Wellpoints (Shallow vacuum pumped, jetted/driven wellpoints shown in FIG. 7)
      F) HDD (Horizontal Directional Drilled shown in FIG. 8)
      The HDD wells are large diameter, and may extend a considerable distance offshore. Because of their size and orientations, these wells can produce very large volumes of intake. Graphic shown in FIG. 9 illustrates how horizontal well flowlines spread intake over a large area and greatly lower intake velocities:

In the case of Vertical, Ranney, and Infiltration Galleries, these can be constructed from corrosion-proof materials, and the vertical wells can include custom-graded filter packs to minimize clogging. Ranney and Infiltrators can have relatively large screen openings to maximize flow and limit long-term fouling. These types of wells are easily and readily serviced using conventional methods. Technology for slant and HDD wells has improved dramatically in recent years. These wells are readily serviced using tried-and-true methods similar to those for vertical wells. All the wells are to be constructed out of highly resistant, marine-grade materials and will have a life extending decades. None of the well types we will use are subject to the expensive and damaging heavy fouling and scaling that occurs with open intake. The concurrent use of multiple well types will maximize the output of the well fields and spread the draw over a large and diverse area.

There will be:
Monitoring wells installed within the well groups to track groundwater behavior/response.
Special design procedures to account for long-term effects and to facilitate the selection of the best available technology.
Thorough well development procedures in original construction to maximize well efficiency.
Regular maintenance and rehabilitation/redevelopment.
Well Redundancy Factor of 1.25 or better to allow for maintenance, service, and extra capacity.
Factored degradation of inflow over time for production

The well fields will need to produce a base production level plus redundancy. Every million acre feet per year raw production translates into an instantaneous rate of 620,000 gallons per minute. Including a redundancy factor loading of 1.3, this value becomes 806,000 gpm. At rated capacity of 5 MAf/yr to make 4 MAf/yr desalinated product, the production rate is about 4,030,000 gpm (loaded) or 3,100,000 gpm unloaded. For planning purposes, this will require approximately 1200 wells if the average production capacity is 3500 gpm.

### Location (Onshore/Offshore), Well Fields, Well Arrays, Well Types

The wellfields will be divided into at least 3 major areas along the westerly side of the Gulf between San Felipe and the south outlet of Laguna Salada, over a zone approximately 100-miles long. These 3 areas include the Southerly Wellfields, Northerly Wellfields, and the Delta Wellfields. Each of these wellfield areas is distinct with regard to hydrogeology and approach to water extraction.

### Southerly Wellfields

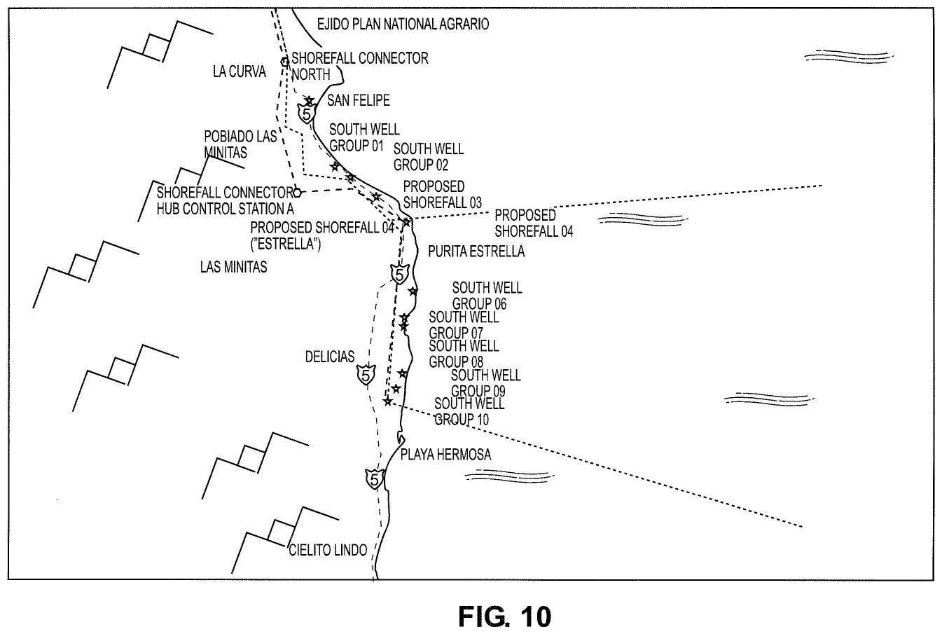

The shorefall sites located southerly of San Felipe will serve as locations for intake wells (refer to pertinent attached maps):
Shorefalls are shore based facilities that transfer water from offshore arrays or transfer brine for disposal. They are situated near the shoreline. Multiple sites have been selected for preliminary consideration, subject to further study to refine.
Note that although only one line is shown, the alignment includes both intake and brine disposal lines in parallel.
Shorefalls 01 through 04 are about 1.5 to 3 miles apart, Shorefall 05 (Delicias) is approximately 11 miles from Shorefall 04 (Estrella).
Two shorefall options, most likely “Shorefall 04” “Estrella” with Shorefall 05 “Delicias” as an alternate location, will serve as the onshore:offshore transition of the brine disposal line—most likely to be a single 12 to 15-ft diameter outfall line that will carry the brine to the discharge eductors array situated near the westerly rim of the Wagner Basin.
The remaining shorefall stations 01, 02, 03, 04 through 10 and 05 (Delicias) will serve as intake hubs for auxiliary seawater wells. Shorefall 04 and 05 may also be set up to serve double duty for intake and brine disposal options.
Intake hubs will likely be sized 24 to 36-inch diameter, each and be served by 8 to 24-inch slant drilled shallow extraction well and HDD wellgroups. Shallow infiltrator wells and similar may also be utilized. They would include valvework, manifolding, and booster pumps.
The Southerly Wellfields will differ from the northerly arrays in that the wells will be groups of large diameter HDD drilled wells that may extend offshore a considerable distance. These wells are expected to have high to very high production rates that may exceed 15 kgpm to 45 kgpm each (depending on actual diameter, length, and sediment permeability).
The developed water from the Southerly Wellfields will join the main conveyance line at Control Station A. Control Station A/Shorefall Connector Hub: Includes valving and booster pumps to tie seawater intake line to main connector. Includes valving, manifolding, and booster pumps, and preliminary aeration for brineline.
   FIG. 10 shows the Southerly Wellfields generalized location as the present invention is applied to solve the environmental challenges of the Salton Trough region.

### Northerly Wellfields

The conceptual basics of the well groups and arrays for the northerly sea-groundwater extraction program areas includes two basic conditions—following the contact line of Salinas de Ometepec using generally high andle/vertical wells, and following seaward any favorable formation conditions with HDD/Slant wells. The other is along the seaward portion of Salinas De Ometepec where extraction may include a variety of extraction methods—slant/HDD, Ranney infiltrator, and high angle to vertical.

The developed water will be manifolded and transferred to the main line via Control Station B:
Main Control Station (Control Station B):
   Is the key control station that processes and combines inflow waters coming up from the south (from Control Station A) with inflow waters developed from the “northerly” well arrays around Ometepec (Well Groups/Arrays A through P).
   The influx waters, once blended and processed, are then pumped and manifolded into the Main Branch Reach.
   The control station will also include valving/mainfolding/booster pumping of the brine line to carry that brine to Control Statin A/Shorefall hub.
   The influx waters from the south will come into the control station in a 15-ft diameter pipe.
   The northerly array lines will likely come into the control station in two 10-ft pipes—one for Intake Well Groups A though G, and one for Intake Well Arrays K through P.
   The lines will be manifolded at the station so the flows can be processed, metered and pumped properly. The 10-ft and 8-ft lines would conceptually be split and manifolded into a series of smaller diameter lines that can be valved and pumped for regulation of flows.
   Brine comes into the control station from the north in a 12-ft to 15-ft diameter pipe, will conceptually be split into a manifold of say six 5-ft diameter sub flows, each valved and equipped with a suitable sized pump—for metering and boost. The brine would then be collected back into a 12-ft to 15-ft diameter outlet pipe.

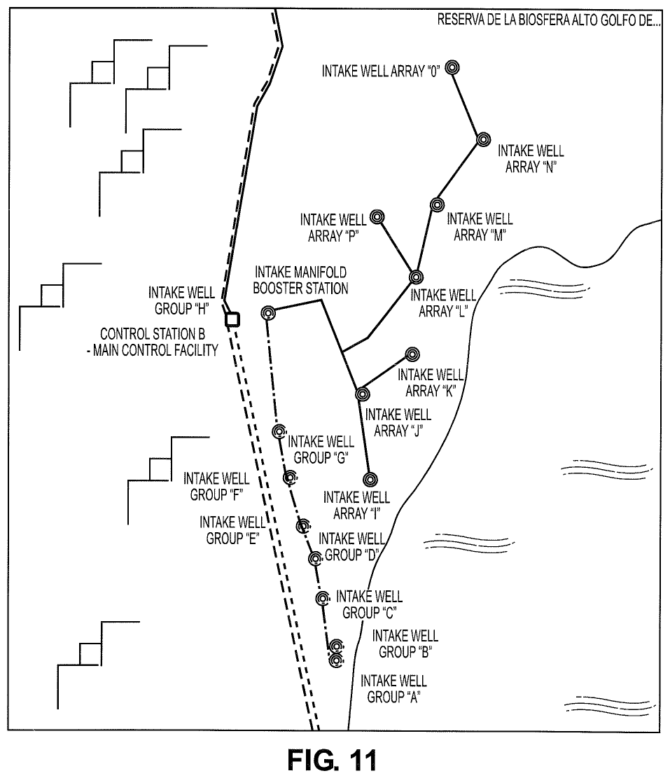

FIG. 11 shows the generalized locations/layouts of the Northerly Wellfields—note that each individual point shown corresponds to subgroups of multiple wells.

### Delta Wellfields

The Delta Wellfields differ from the Northerly and Southern Wellfields in that they are inland of the Gulf waters. However, these sediments are believed to be in contact with tidal influenced seawater and also act as a large reservoir for salinity buildup in the lower Mexicali Valley and saline subflows from Laguna Salada. Mining this water is a key aspect of the proposed reclamation work to eventually desalinate the upper portion by a combination of sustained pumping and new freshwater flows to be provided as part of the reclamation work where 500K acre feet per year of Colorado water will be repurposed to habitat so the river again makes it to the Sea and begins to restore delta and estuary habitat. These wells will be combination groups of vertical/high angle, and locally HDD/slant following favorable formation conditions. The Delta Wellfields may be supplemented temporarily (or metered) by Ranney and Shallow Infiltrator assemblies for to enhance preliminary salt removal.

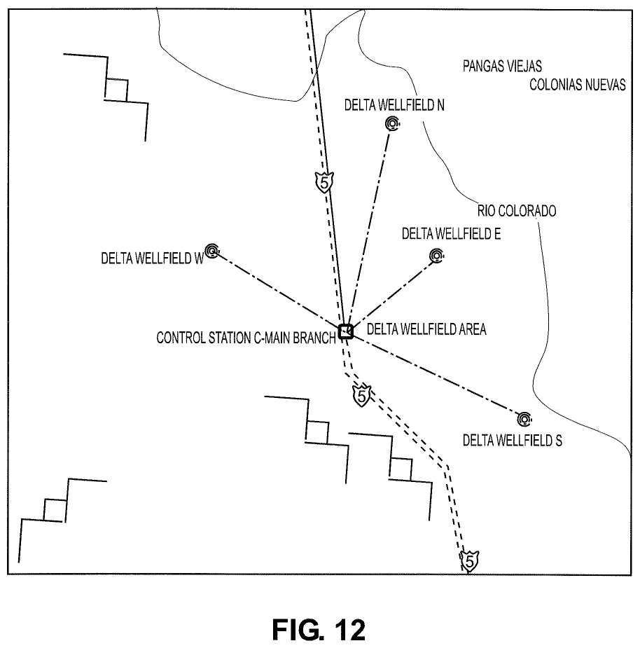

The Delta Wellfields will join the Main Conveyance Line at Control Station C. FIG. 12 illustrates the general layout/locations of the Delta Wellfields. As with the other wellfields, each point shown corresponds to multiple (literally hundreds) wells within a grouping.

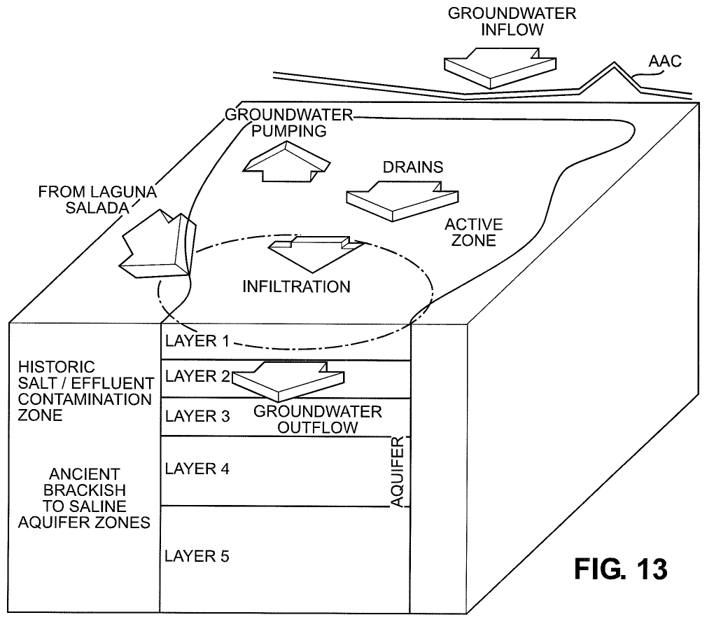

Multiple horizons of saline groundwater will be mined in this location. FIG. 13 presents an illustrative block diagram of the Delta Wellfields Area. The upper horizons reflect historic groundwater contaminated by salts from the stagnation of the Colorado River and human development effluent. These correspond to Layers 1 through 3 on FIG. 13. The lower horizons (layers 4 and 5 of FIG. 13) represent more ancient waters and marine sediments affected by ocean waters. The different individual zones will be serviced by separate well groups.

### Transport and Delivery

### Main Conveyance Pipeline System

The Main Conveyance Pipeline carries developed raw sea-groundwater to the Processing Hub at Cerro Prieto. It also includes the return Brineline that conveys brine and reclamation reject materials to the outfall processing station at San Felipe. As already discussed, the Main Conveyance Line includes several Control Stations that manifold, pump, meter/control, and distribute flows. The Main Conveyance Line begins at Control Station A/Shorefall Connector Hubs at San Felipe where water from the Southerly Wellfields is introduced. The line at this point is a single barrel 15-ft raw intake line and 12 to 15-ft Brine Return Line.

From there the line follows the highway about 37 miles to Control Station B where the Northerly Wellfields are collected. The Intake Array expands from 1×15-ft to 2 or 3 bbl 15-ft.

Approximately 35-miles northerly, the Main Conveyance Line picks up the waters developed in the Delta Wellfields and gains another 15-ft diameter barrel at Control Station C. At this point the water is carried approximately 40-miles to the Cerro Prieto Processing Hub.

### Service Distribution

Primary conveyance is by service line to the US border/All American Canal at Yuma/Morelos Easterly; Mexicali Central; and El Centinela Westerly. Water is to be provided and distributed by “in-lieu storage” via the All American/Coachella Canals and also by direct pipeline connection (Salt River Ariz./San Diego—Salton Sea, Calif.).

The Westerly and Central Service Distribution Lines will likely be 3×8-ft diam lines that have a combined capacity of up to about 1.5-MAf/yr. It is likely that the Central service will be 2×8′ delivery and 1×8′ for reclamation disposal (municipal and New River wastewaters) The Easterly Line will be a 2×12-ft assembly in addition to possible supplemental service lines for Reclamation purposes. One of the 12-ft lines is largely dedicated to supplement Mexican uses, the other is available for deposit into the All American Canal and or direct pipeline connection.

All pipelines are to be preferably made of the most modern plastics available to have extra smooth internals to maximize efficiency and flow. It is likely that these pipeline arrays will be formed directly onsite by rolling factory setups. Capacities and sizing are for preliminary planning herein, and will be refined as more information is developed and the project evolves.

Where practical, pipelines are to be buried. There are a few locations along the alignments where the lines may need to be on or above ground.

The lines will cross multiple areas of direct seismic risk (ground distortion/rupture from active faulting, liquefaction/lateral spread). Special foundation accommodations will be required.

Considering the exemplary embodiment of the present invention as applied to the Salton Trough, prospective water users include:

Mexico (as a portion of negotiated royalties)

### Lower Colorado Basin User States

Direct pipeline connections

### Reclamation—Salton Sea Mitigation

### and Mitigation of Upper Gulf/Lower Colorado River Delta

### Energy Sources

The system will require a very large amount of power to operate. The main energy demands are anticipated to be:
Wellfield pumping;
Conveyance pumping;
Brineline pumping and pressurization;
Aeration and Oxygen concentration;
Desalination;
Plant and Facilities Operations

The primary source of power is geothermal. The geothermal energy will generate electricity directly for use in the project and elsewhere in Mexico. Waste heat from geothermal electric generation will be used by desalination operations.

### Cerro Prieto Geothermal Field

Cerro Prieto is the world's second largest geothermal field, and is the largest in Mexico/Latin America. The geothermal energy is present because of tectonic rifting in combination with very high sedimentation rates of the ancestral Colorado River. The rifting has created a parting in the crust of the earth, that not only allowed the unzippering of Baja from the mainland and created the Gulf, it also created hot spots where heat from the upper mantle of the earth is in contact with water filled sediments. The temperatures of these sediments ranges from 200 to over 350-deg C. Underlying this primary zone are other zones of heat collection—both “wet” containing both liquid and gas, and mostly “dry”—particularly the area of the underlying spreading center where the heat comes from. The temperatures of the deeper wet zones may locally be over 350-dec C, and the “dry” underlying zones may be much higher. With proper management, this situation creates an almost inexhaustible supply of heat.

Note that a considerable degree of upgrading and expansion of the Cerro Prieto field will be required for the project. Other sources of energy to supplement the geothermal will be used as well—including dedicated onsite solar and imported wind power (ie. La Rumerosa windfarms). Supplemental power may also be available from the Salton Sea KGRA fields in the adjacent US.

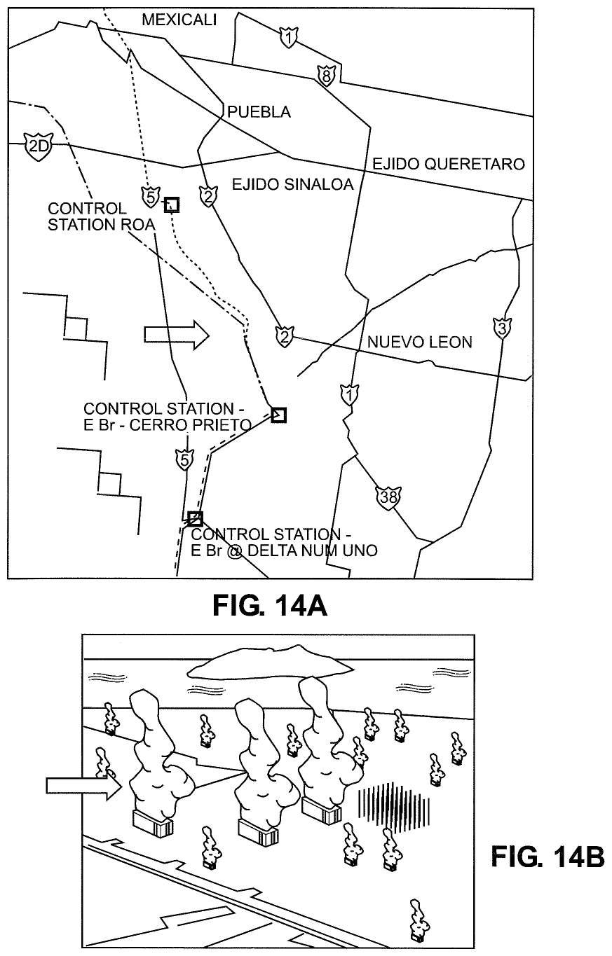

FIGS. 14A and B shows the area of Cerro Prieto, as excerpted from Google Earth. Note the Volcano (red arrow) (Inset shows oblique aerial of area—looking westerly, hill in background is volcano).

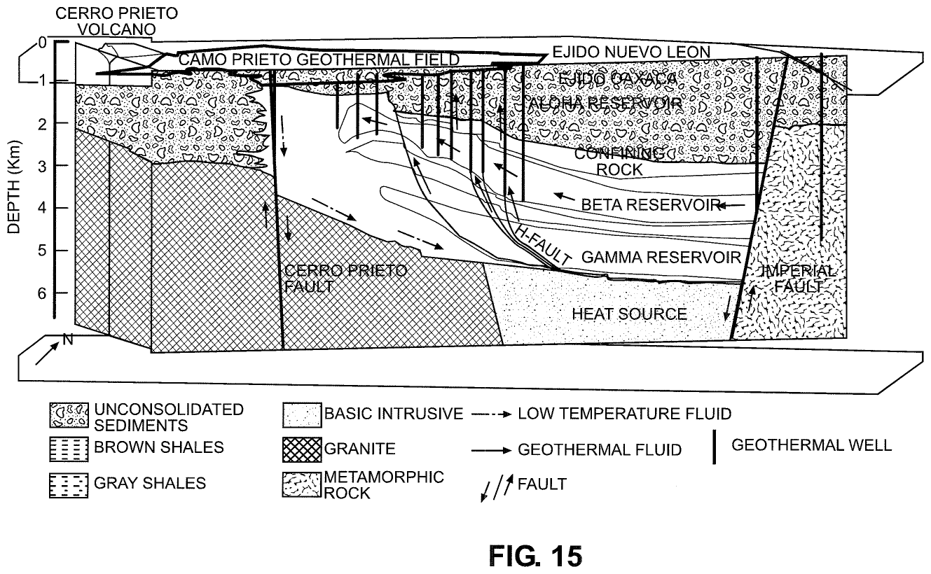

FIG. 15 presents a block diagram view of the structure underlying Cerro Prieto (From Prol-Ledesma, Arango-Galvan, and Torres-Vera, 2016).

The following was excerpted from Rigorous Analysis of Available Data from Cerro Prieto and Las Tres Virgenes Geothermal Fields with Calculations for Expanded Electricity Generation by Prol-Ledesma, Arango-Galvan, and Torres-Vera in Natural Resources Research, Vol. 25, No. 4, December 2016

Changes in legislation have opened the Mexican geothermal resources for exploitation to private companies; therefore the evaluation of the known geothermal areas has a high priority to plan further exploitation and possibly the expansion of the well fields. The calculation of the remaining productivity of geothermal fields currently in exploitation can be achieved with less uncertainty using the parameters obtained from production and injection wells, as well as the production efficiency of the installed plants. No information about previous volumetric evaluation is available for the fields presently being exploited, and there is the possibility that they may support an increase in their energy output or extend further their production life.

The most widely used calculation technique is the USGS volumetric method that requires the knowledge of parameters that can be measured only after exploitation started. Heat in place-volumetric evaluation was undertaken for two fields in Mexico: Cerro Prieto and the Las Tres Vírgenes geothermal fields, using all information obtained by exploration surveys and exploitation drilling. The obtained values allow planning a possible expansion of the fields based on their estimated mean potential output that is 1397 MWe for Cerro Prieto and 48 MWe for Las Tres Vírgenes compared to the presently installed capacity of 580 MWe.

### CPGF Production History

The CPGF is the largest producer of geothermal energy in Mexico. In 2005 it produced 50% of the electricity (720 MWe) required in the NW part of the country (Portugal et al. 2005a). The long exploitation history of Cerro Prieto has been summarized by Gutiérrez-Puente and Rodríguez (2000), Lippmann et al. (2004), and DiPippo (2012). Presently, the field is divided into four areas: CP-I (Cerro Prieto I), CP-II (Cerro Prieto II), CPIII (Cerro Prieto III), and CP-IV (Cerro Prieto IV).

CP-1 was the first part of the field to be exploited in 1973. The CPGF reservoir has been divided into three sections: alpha, beta, and gamma. The alpha reservoir is restricted to the western part of the field; it is the shallowest one (depths are between 1000 and 1500 m; Gutiérrez-Puente and Rodríguez 2000). The beta reservoir is deeper (depths ranging from 1500 to 2700 m) with a minimum area of 15 km2 (Portugal et al. 2005b); its temperature is much higher than that of the alpha reservoir and its top is defined by the upper limit of the silica-epidote continuous occurrence (Cobo 1979). There are no reports of exploitation of the gamma reservoir (Izquierdo et al. 2001), which is the deepest and hottest portion of the reservoir contained in the sand unit found below 3300 m depth with temperatures probably above 350_C (Lippmann et al. 1991). It has been hypothesized that temperatures above 350_C predominate at least over an area of approximately 5 km2 in the Nuevo Leon section of the field (Castillo et al. 1981) that would be the minimum value of the gamma reservoir extent.

The parameters of the deepest reservoir were estimated using completion and reservoir data for the deep well M-201 (depth=3820 m) to simulate pseudo-transient flowing conditions (García et al. 1999): pressure—321 bar; temperature—350_C; porosity—0.15; transmissivity—8 Darcy-m; reservoir thickness—300 m; rock thermal conductivity—1.7 W/m K; rock density—2500 kg/m3.

Currently, the CPGF production is generated by 9 units (Flores-Armenta et al. 2014)—four 110 MW double-flash, four single-flash of 25 MW each, and one 30 MW single-flash, low pressure—amounting a total of 570 MWe, as the four 37.5 MW units in CP-I were decommissioned in 2012. The power units produced 3996 GWh in 2013 at an annual capacity factor of 78% with an annual average consumption of 8.5 tons of steam per MWh (Flores-Armenta et al. 2014), while in 2011 the capacity factor was 72% (Flores-Armenta 2012).

Based on early simulations of the first three exploitation stages for a period of 20 years, the pressure could at the end of this period be maintained close to 100 bars and the reservoir enthalpy would decrease to 1030 kJ/Kg, corresponding to a liquid water temperature value of 237_C (Castañeda et al. 1983). However, more recent numerical models (Antunez et al. 1991; Butler et al. 2000) agree that the most reliable source for long-term production, in order to ensure a 30-year long generation of at least 600-700 MW, would be the beta reservoir (deeper than 1600 m). This statement has proved to be realistic as most wells in the alpha reservoir have now been shut. Some authors (e.g., Lippmann et al. 2004) stress the fact that large deep parts of the reservoir still remain unexploited and they could support future expansion of the field given the high temperatures expected. Parameters for Volumetric Evaluation of the CPGF Available data from the CPGF that can be used as input to volumetric evaluation. The only reservoir section that currently has enough information to be considered for a consistent volumetric evaluation is the beta reservoir. It extends over most of the well field at depths below 1600 m for at least 15 km2 (Portugal et al. 2005b) and has an estimated minimum thickness of 1600 m (Butler et al. 2000). The area that bounds the producing area of the CPGF as reported by DOE-CFE (1982; in Castañeda et al. 1983) is 19.5 km2, liquid water was the dominant phase in the reservoir but exploitation induced local boiling and the presence of small two phase areas (Grant et al. 1981). However, the reservoir remained liquid dominated. Castillo et al. (1981) reported that the maximum thickness of the reservoir is about 2 km and the maximum value for the area is 30 km2 (Castillo et al. 1981) on the basis of the observed high electrical conductivity anomalies. The maximum temperature measured in the eastern part of the field is 350_C (Lippmann et al. 1997).

Exploitation data from Cerro Prieto for 28 years indicate minimum and maximum temperatures of 280 and 350_C, respectively (Gutiérrez-Puente and Rodríguez 2000). Production data indicate a mean temperature of 320_C (DiPippo 2012). Feeding hot fluids (T>350_C) from the deepest reservoir (below 3300 m; Lippmann et al. 1991) have helped to keep the high temperatures of the beta reservoir. Therefore, even after more than 30 years of continuous exploitation, the beta reservoir was still keeping a maximum temperature close to 350_C (Gutiérrez-Puente and Rodríguez 2000). This hot recharge with the high porosity and transmissivity detected for the beta reservoir (Butler et al. 2000) validate the use of a recovery factor in the range of 0.10-0.25 for the CPGF beta reservoir (Garg and Combs 2010; 2015; Williams 2014). The inlet saturation temperature of the low pressure turbine in CP-II and CP-III is approximately 135_C and the utilization efficiency is 49.3% (DiPippo 2012). This temperature can be assumed as the abandonment temperature for the volumetric evaluation.

In addition to the evaluation of the beta reservoir, the minimum potential of the gamma reservoir was estimate using the minimum values for the reservoir parameters suggested by different authors and production parameters of CPIV. The future exploitation of this section of the reservoir would be an important contribution to the energy output of the CPGF.

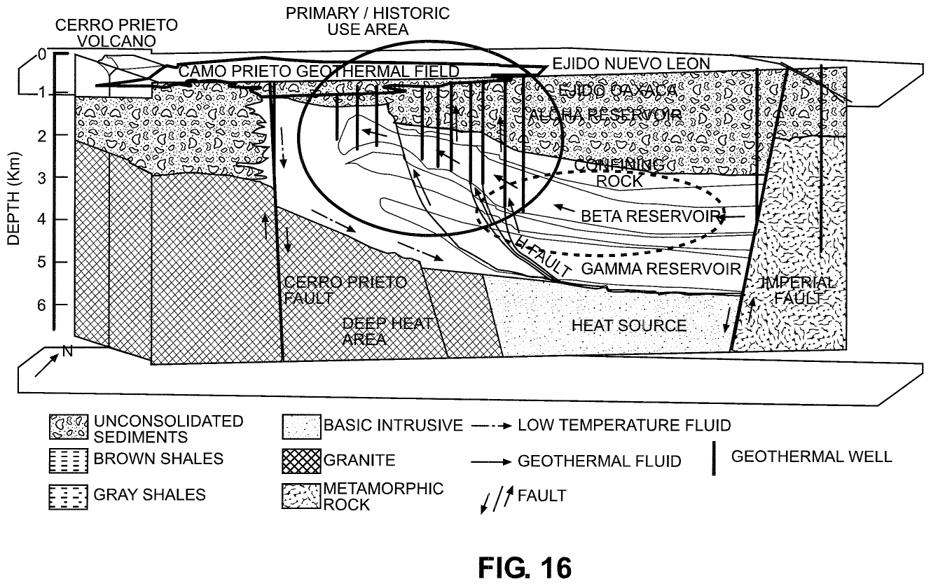

The data supports that there is significant energy output available at the preferred embodiment installation related to the Salton Trough to allow for desalination and co-generation (electricity and geothermal desalination). Significant supplemental study will be required to prove this up. The current field will require significant rehabilitation and upgrade, and would need to mine heat/geothermal from all available levels, not just the 200 to 350-deg C. Beta horizons. A similar field is present in the US at the South Salton Sea KGRA to provide supplemental power as needed. FIG. 16 shows the generalized section of the Cerro Prieto Geothermal Field with use areas highlighted.

The viability of the Cerro Prieto field was also confirmed in more recent studies: Subsurface structure revealed by seismic reflection images to the southwest of the Cerro Prieto pull-apart basin, Baja Calif. by Gonzalez-Escobar, Mares Aguero, et al in Geothermics, v85, May 2020; and Extension In Geothermal Fields Between The Imperial And Mexicali Valleys Revealed By 2D Seismic Imaging And Joint Gravity-Aeromagnetic Modeling by Reyes-Martinez, Gonzalez-Escobar, et al in Geothermics, v89 January 2021, “2D gravimetric and aeromagnetic models constrained by seismic data demonstrate the presence of zones of sediments metamorphosed by hydrothermal alteration fronts due to major faults and intrusions. We present for the first time a geologic model supported by geophysical data that cover transversely the entire Mexicali Valley.

Finally, we identify three domains for future geothermal exploration in the Mexicali Valley, supported by the analytic signal of the aeromagnetic data after reduction to the pole and seismic reflection profiles from previous papers.”

### Geothermal Energy Extraction Theory/Application

Geothermal energy in areas like Cerro Prieto is developed by directly mining hot liquids and gas solutions (“multi-phase”) from the production area of a geothermal field, and treating the solution further by reducing its confinement pressure such that more of the liquid component changes phase (or “flashes”) into steam. This steam is put to work to drive turbines that generate electricity. Where temperature and pressures are favorable, the remaining liquid is separated off to a second flashing unit to drive a second turbine. These units are called double flash systems and have higher inherent efficiency than singles. The leftover liquid and spent steam is then collected, cooled and reinjected into a recovery zone of the geothermal field where it migrates back to the production area, gaining heat from the thermal source.

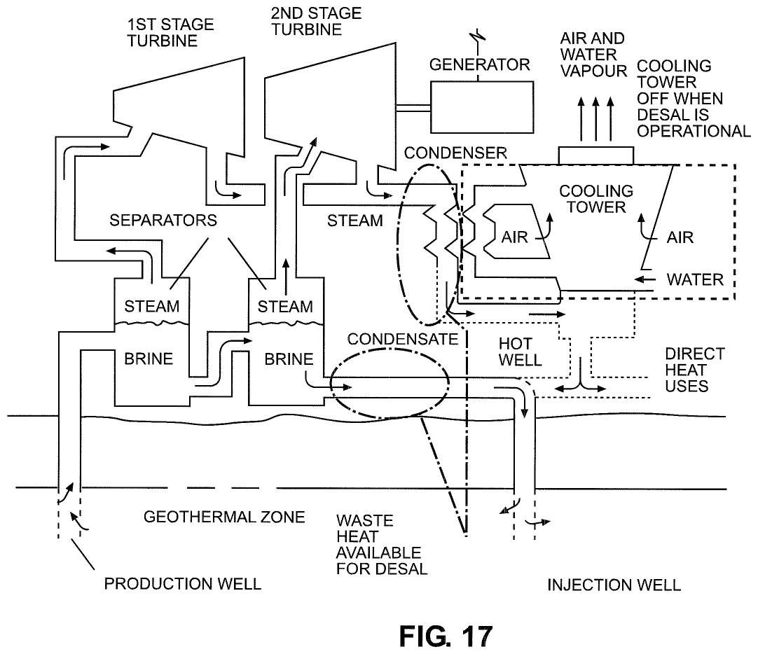

FIG. 17 shows a typical plumbing of a double flash geothermal power plant (as presented by Engineering Notes Online). As can be seen, a considerable amount of heat bypasses the system even with the second flash unit. This heat is what the Program will use to provide means for distillative desalination.

### Co-Gen Geothermal

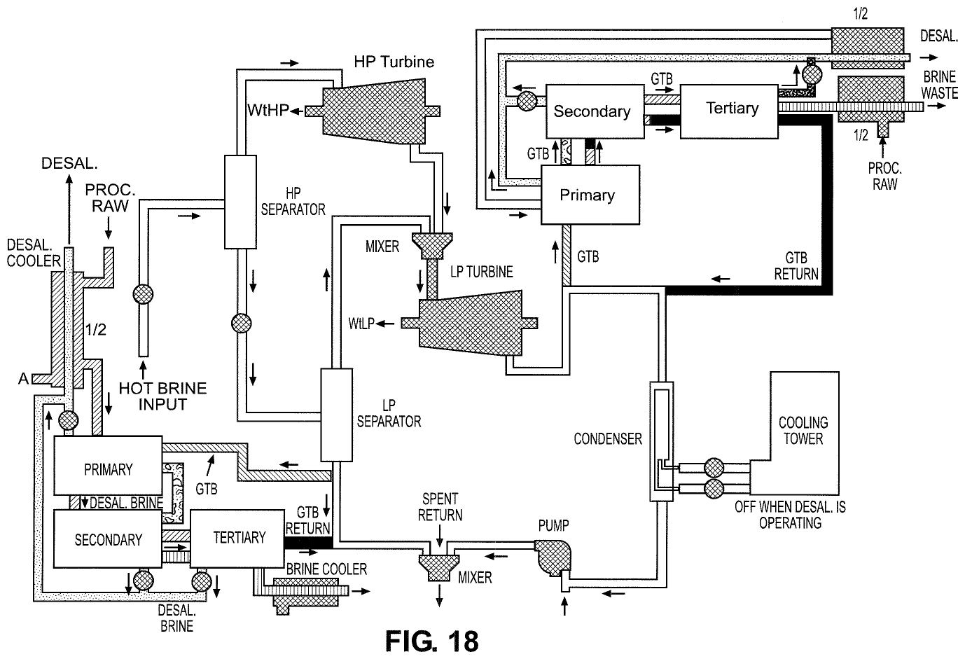

FIG. 18 is a Series Parallel Water Heat Scavenging for Geothermal Desalination and includes a schematic on the downstream waste heat scavenging and heat management of the geothermal driven desalination. The figure illustrates that the plants heat take off drives a series parallel array of desalination units on a primary, secondary and tertiary level and puts a significant amount of waste heat to work. The spent geothermal fluids are then collected and appropriately reinjected into the field. Note that the incoming raw water charge will cool both the outgoing desalinated water and the brine tail wastestream. Also note that the cooling towers will be bypassed while the desalination is operational. Each plant/subfield would have its own systems. The produced and other waters would be collected and manifolded to final processing.

### Direct Heat Mining

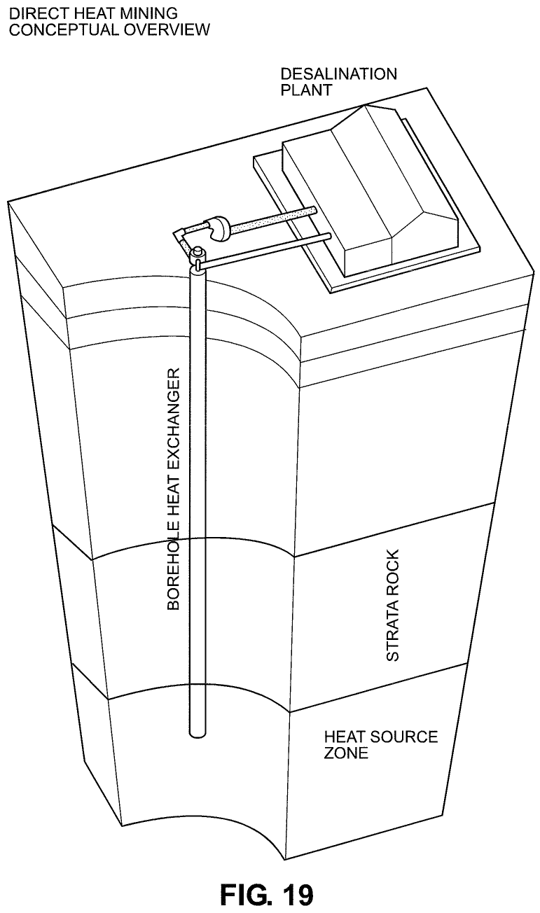

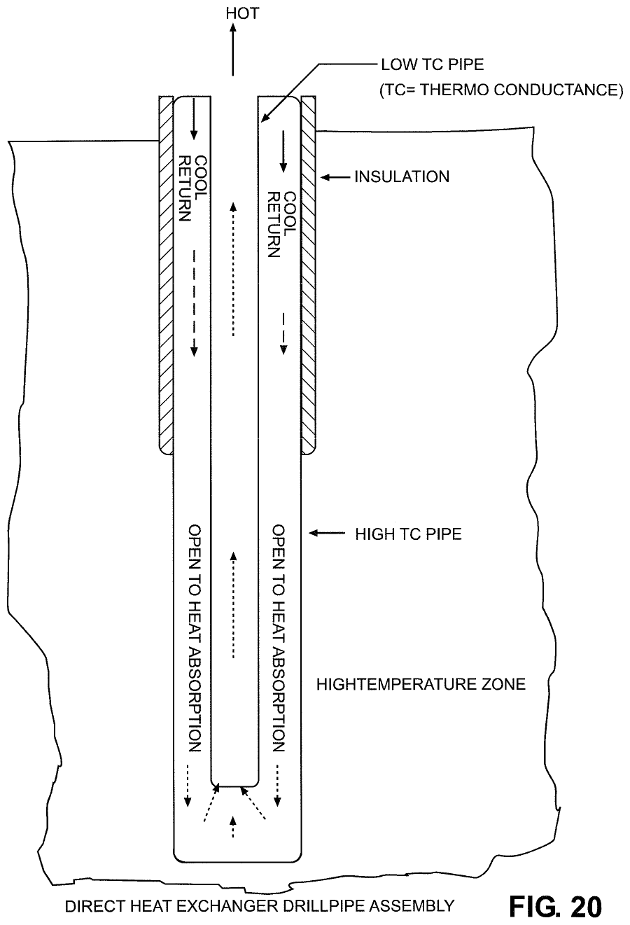

Direct heat mining utilizes a series of special drill pipes that have been modified to recirculate special coolants (brine, sodium, or similar) that extend into the deeper high temperature zones of the geothermal field. This may include tapping into the upper heat source rocks. The absorbed heat is directed to desalination facilities for use. This is currently highly experimental and may require significant adjustment and controls to operate—however it has the potential to greatly expand the available energy. FIG. 19 shows the concept of direct heat recovery, and FIG. 20 shows the specialized heat exchanger drillpipe.

### Supplemental Solar

Solar power may be used as a secondary energy source. Most of the solar onsite at the processing plant are currently envisioned to be in the form of direct solar desalination using best available technology. Solar distillation will also be used with brine precooling treatment to recover additional product.

### Final Processing

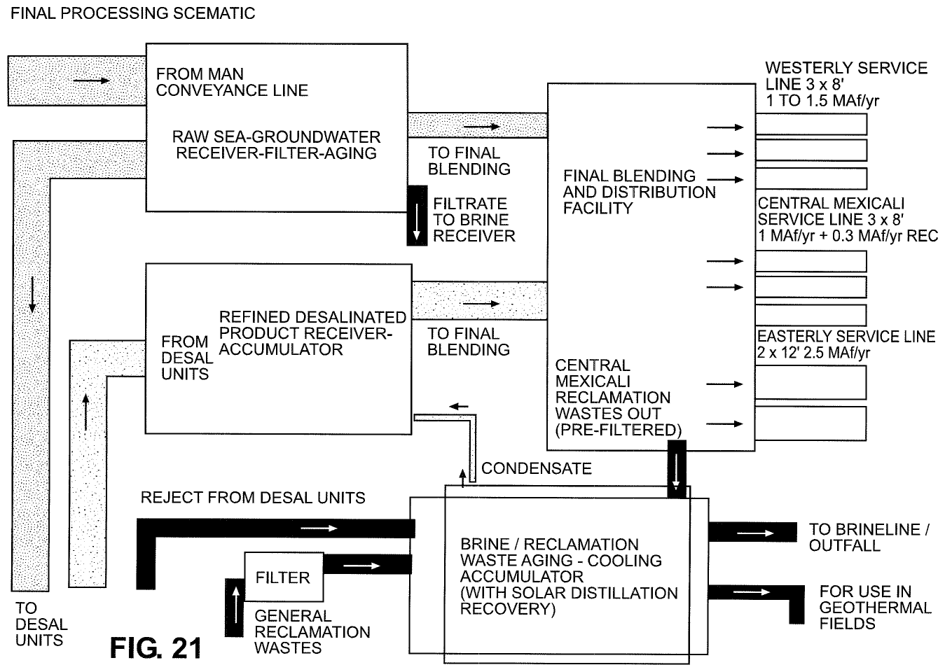

Final processing receives the final product and waste materials and prepares them for final blending and distribution to the various service lines. Incoming raw sea-groundwater is received, accumulated and aged for distribution to the desal units. Brine reject and reclamation wastes are also accumulated, cooled, and aged for disposal. The brine processing will include solar scavenging distillers to capture and recover evaporation as fresh water condensate. FIG. 21 presents a schematic overview of the final processing.

### Brineline Disposal System

### General Summary

The Brineline disposal system carries the reject/waste materials (“brine”) for water production and related reclamation objectives to a final processing facility at shorefall, where the brine is blended with treated municipal WWT reject, and is also thoroughly aerated using best available technology. From there the processed brine moves via offshore pipeline to an outfall location located along the westerly edge of Wagner Basin. This area is about 20 to 25-miles offshore of San Felipe.

The brine is dispersed into a manifold situated as a line along the edge of the basin that includes several large scale actively tunable educator venturies. Brine is metered into the eductors under pipeline pressure. The educator mixes the brine with surrounding ocean water at a rate of approximately 4:1 (See FIG. 13). The educator venturi cone mixes the two liquids in turbulent flow. This flow is enhanced by the installation of turbolator fins/flutes in the venture cone. The turbolator introduces a shear spin that adds turbulence, tends to fold edgewaters into the cone area for improved mixing. This is accomplished with no moving parts available to harm marine life that could be exposed around the eductors.

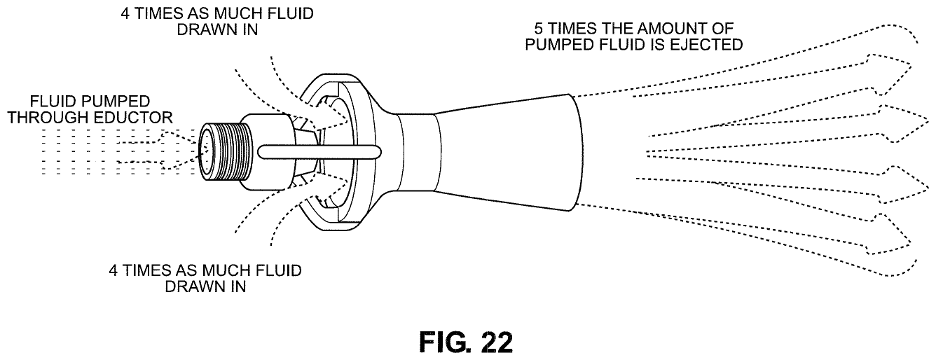

The processed and blended brine will be mixed to a point that it will be close to ambient seawater character as it leaves the educator cone, and very close to ambient conditions within a short distance where it can expand and disperse. This will occur in deep water mid-water column zone. The flow thermodynamics and engineering attributes of this system provides significant improvements to mixing, dispersion and reduction of environmental hazards over conventional open-nozzle outfalls. FIG. 22 depicts the Eductor Venturi Basics.

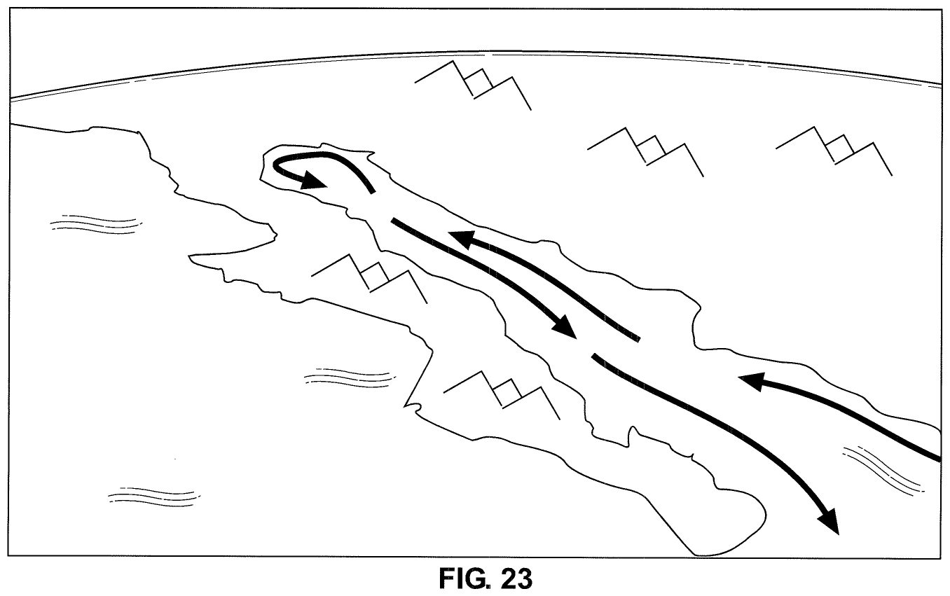

The manifold array will be anchored to the sea floor that drops into Wagner Basin—which ultimately continues descent in a stair-step fashion into increasingly deeper water and ultimately the East Pacific. This creates an oceanographic condition that channels “deepwater” currents. These currents will be utilized to disperse and carry the outfall plume through the Gulf and into the Pacific. FIG. 23 shows the generalized current pattern with the preferred embodiment as applied to the Salton Trough implementation.

Eductors will be located along a manifold line. This manifold line is a specialized pipeline that accommodates an array of eductors and transfers brine from the subsea pipeline and makes it available to the eductors for dispersal. The manifold line will likely be 1 to 2 miles in overall length, and it is estimated to carry 20 eductors or more. The eductors are each individually tunable for flow and direction. The system will include a series of strategically placed monitoring buoys that will provide live updates on sea conditions, salinity, temperature, and dissolved oxygen. This information will be used as feedback for tuning the array to meet changing sea states that are common in the Gulf.

### Return Line

For planning purposes, the brine Return Line is to be a single 15-foot line. To allow for flexibility and better effectiveness in transport, this line may be changed to a multiple barrel array of smaller pipe. This may be 3 bb1×8 to 10′. The Return Line parallels and is a part of the Main Conveyance Line, and runs from Cerro Prieto to the Shorefall Final Processing station at San Felipe. Brine materials, as shown in FIG. 12, are accumulated, and allowed to age and cool. The processed brine the is pumped into the Return Line for delivery. The Return Line is serviced and regulated by inline Control Stations that are part of the Main Conveyance Line.

It should be noted as part of the subject work, and as was part of the original goals, we intend to assist the local people of Mexico that are to be shareholders/stakeholders in the subject project. Infrastructure is to be extended to Mexicali, Morelos Dam via Central and Easterly Service Line Alignments, and to San Felipe following the Brineline. The infrastructure provisions include fresh water, municipal wastewater effluent disposal, and electricity.

### Shorefall Processing

The Shorefall Processing Station at San Felipe performs three primary duties:
It takes the Brineline terminus flow and blends it with treated Waste Water Treatment effluent at San Felipe.
It thoroughly aerates and oxygen enriches the blended reject using special technology.
It pumps and pressurizes the aerated processed liquid into the Outfall Offshore Transport line.

The line will need to be highly pressurized so it can be mobilized for the 20 to 25-mile journey along the sea floor to the manifold educator array outfall. The Shorefall Processing station may also handle local Southern Wellfield influx waters, and direct them to the appropriate Main Conveyance control stations. The salinity of the brine blend is likely to range up to 210 Kppm.

### Offshore Transport

Offshore transport is to be via a 12 to 15-foot pipeline of super smooth FRP, plastic or other best available material that can handle high pressures. The line pressure needs to overcome ambient pressures and have enough remaining pressure to flow to the outfall with sufficient reserves to operate the eductors. At 300-ft depth, an ambient pressure of about 130-psi is present. This suggests that a working pressure of about 300-psi will be needed at the educator.

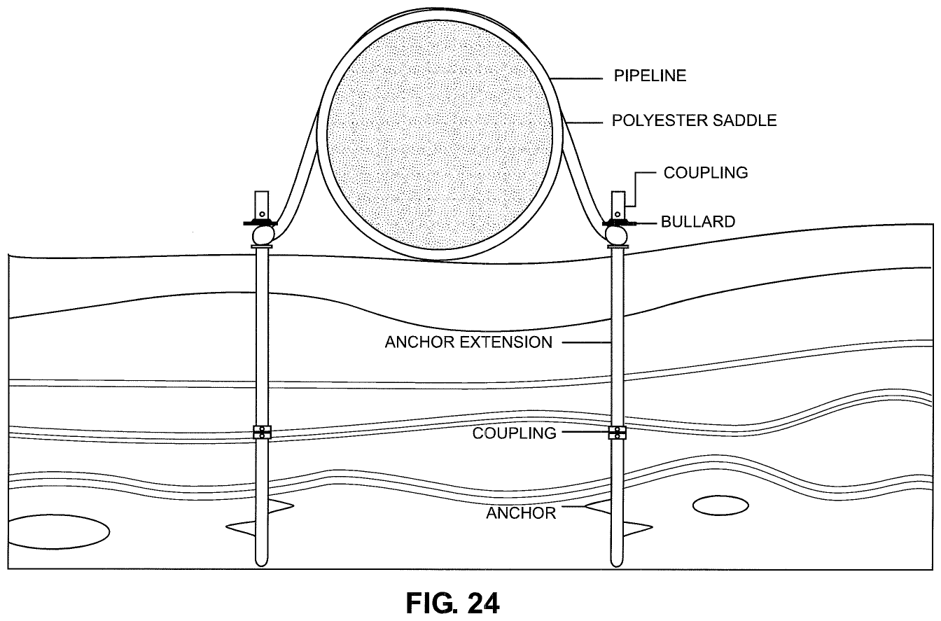

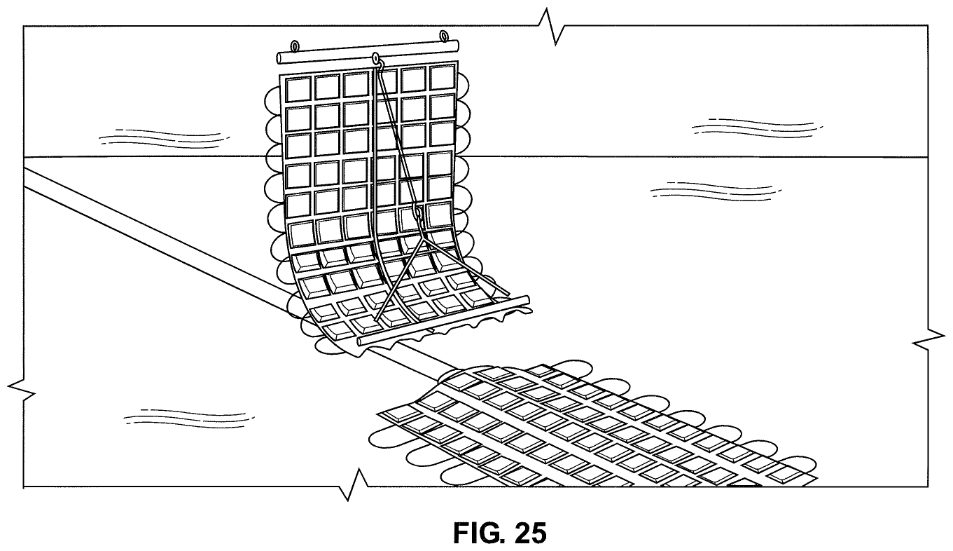

The inside of the pipe will be spiral fluted to rotate the flows inside the pipe and assist in keeping the aeration in suspension. Also, in a preferred embodiment, the pipeline will be laid on the sea floor, and anchored by a combination of direct anchoring and covering with appropriately sized and anchored Armorflex Mats or similar concrete mattressing. FIGS. 24 and 25 illustrate pipeline anchoring to the seabed.

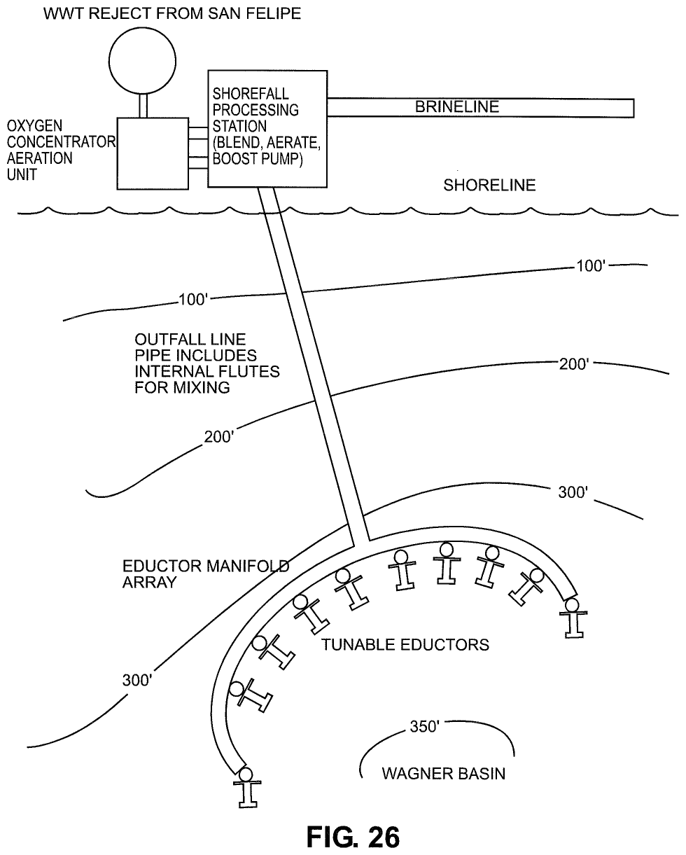

FIG. 26 shows a general overview of the Brineline Return, Shorefall Processing and Offshore Transport and Disposal.

### Disposal Eductor Array

The Eductor Array and its associated manifold is one of the crown jewels of the program. As described above, the outfall is handled by a specialized array of tunable eductors that blend and disperse the brine effluent with ambient seawater with a very high efficiency and low risk to marine life.

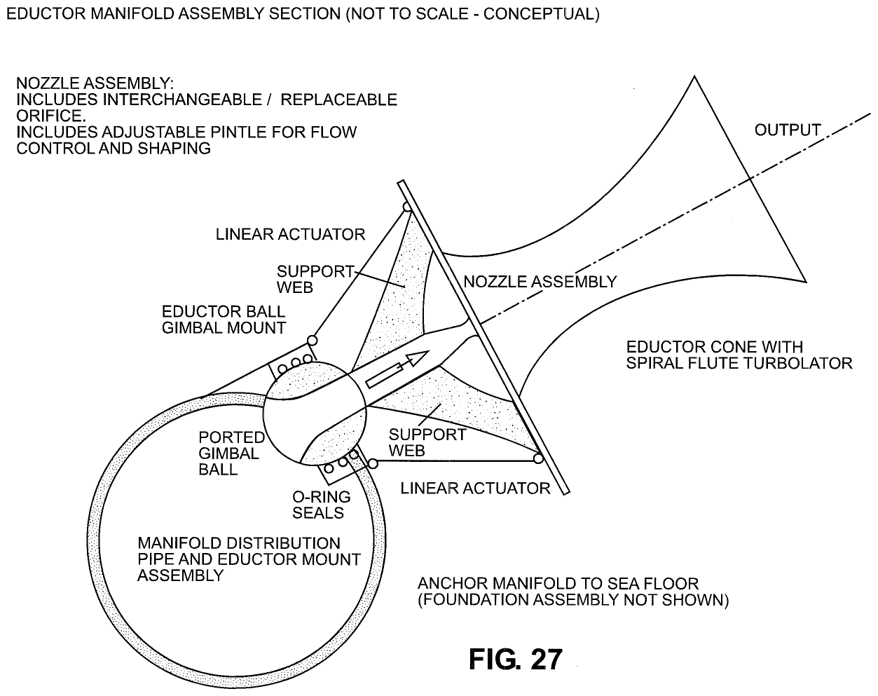

The Eductor Array and its manifold are interconnected into the end of the Offshore Transport line. The assembly is firmly anchored to the sea floor. Oceanographic conditions will be monitored by an array of strategically placed offshore buoys that will provide live detailed information about the water column salinity, temperature, dissolved oxygen content, sea state and other information. This information will be used to make adjustments to the outfall system and track effectiveness. FIG. 27 shows a general section of the Manifold and Eductor of the present invention.

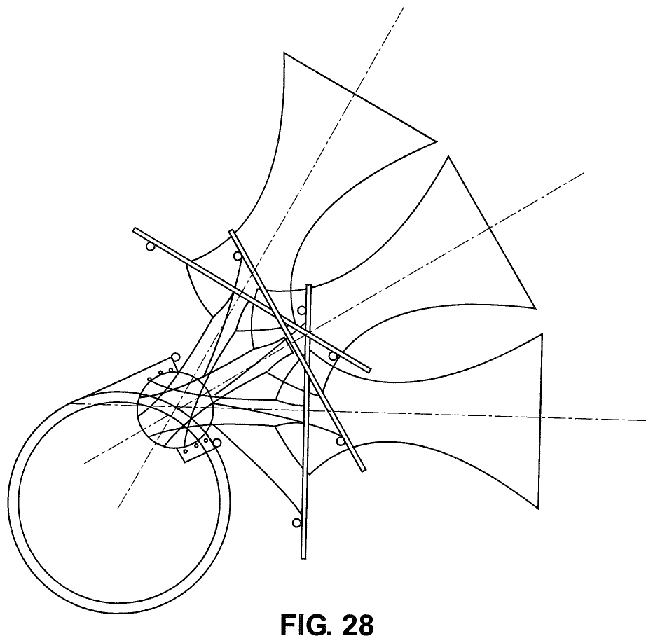

FIG. 28 Illustrates the Range of Motion of the Eductors (motion is about 50 to 70-deg, lock to lock, 360-deg about gimbal( ).

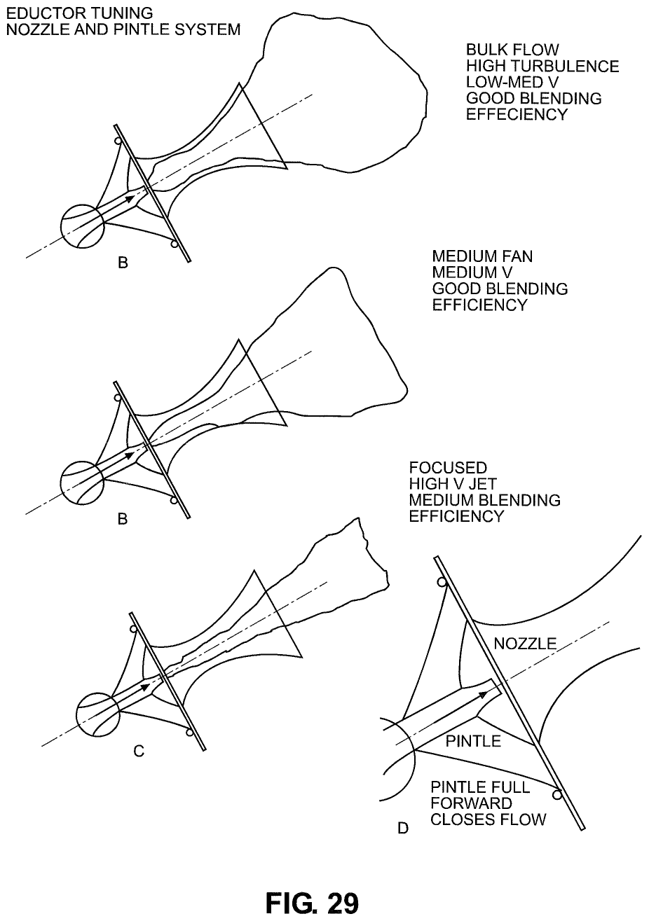

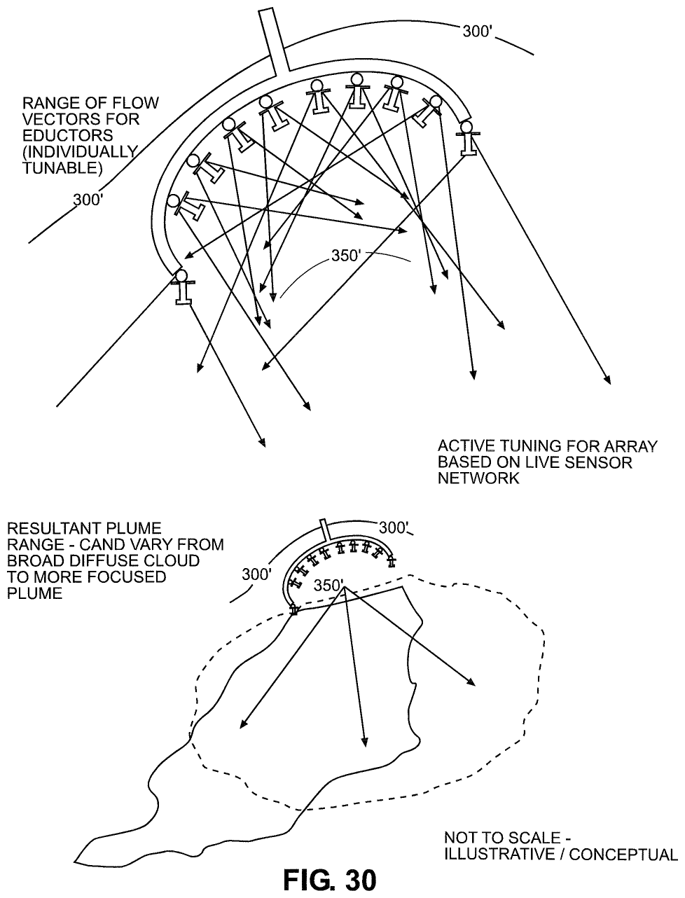

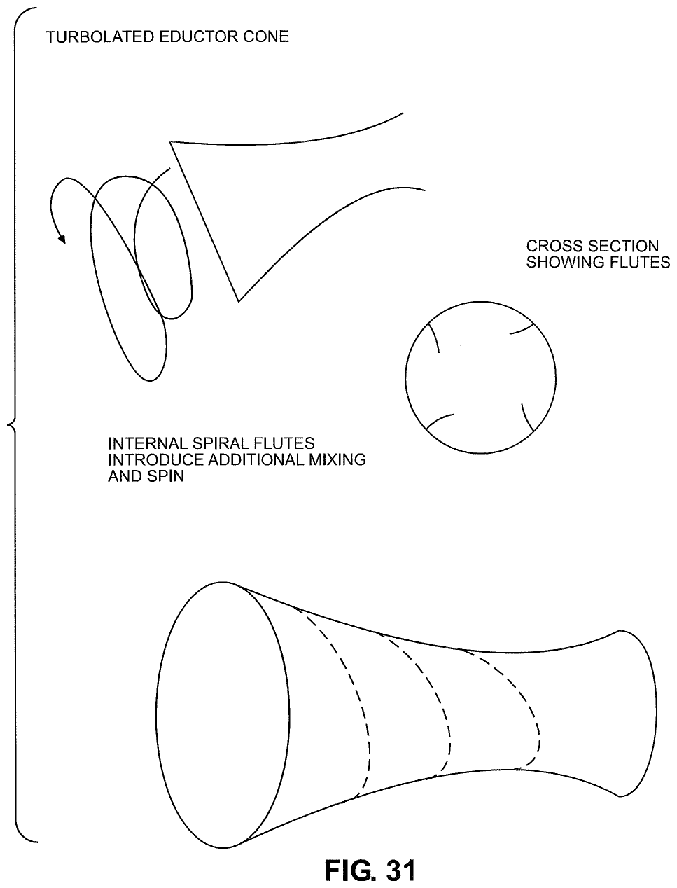

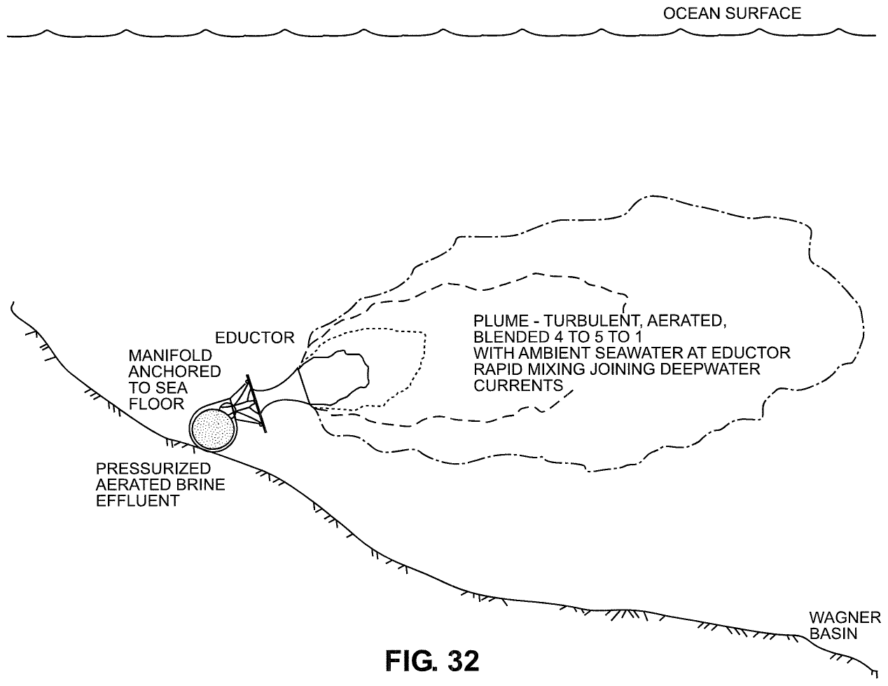

FIG. 29A-D Shows how the educator is tuned. Note that the Nozzle includes removable components that include the tip, the sea, and pintle so that the proper flow can be used and service is simplified. FIG. 30 Shows the Range of Focus of the Eductor Array. FIG. 31 Shows the turbolator to be added to the Venturi Cone to mix and spin the brine solution leaving the eductor. FIG. 32 Illustrates how the Eductor plume propagates away from the eductor array and into the surrounding water.

The present invention as described herein is intended to describe a system and process for reclamation and remediation of dire environmentally challenged areas. In a preferred embodiment, the present invention is a viable answer to the Colorado River and the environmental issues of the Salton Trough and Northern Gulf, and will have the side effects of strong mitigation of salt and waterlogging issues and habitat restoration of the delta and estuary in lower Mexicali, improve social issues in Mexicali, San Felipe and the New River by infrastructure improvements, and allow for the stabilization and mitigation of the Salton Sea.

It is to be appreciated that the integrated sea-groundwater and tuned outfall desalinization system as shown and described herein is applicable to a variety of environmental conditions requiring remediation and reclamation. The present invention has been described in conjunction with a specific geographic area and particular environmental challenge of the Salton Trough region of Southern California and the Baja Calif. region, however, this is not to be construed as a limitation on the applicability of the present invention. The present invention includes systems and methods which are suitable for treatment of a variety of environmental topography and conditions.

While there have been shown what are presently considered to be preferred embodiments of the present invention, it will be apparent to those skilled in the art that various changes and modifications can be made herein without departing from the scope and spirit of the invention.

We claim:

1. A integrated sea-groundwater and tuned outfall desalinization system
a sea-groundwater source piped to a desalinization plant;
a return Brine-Line that conveys brine residuals from said desalination plant;
a means for diluting and blending said brine to create a solution;
a means to aerate said solution; and
a means to distribute said aerated solution to a deep water offshore array to convey the outfall into the ocean.
